(19) United States
(12) Patent Application Publication
(10) Pub. No.: US 2015/0253484 A1
(43) Pub. Date: Sep. 10, 2015

(54) ILLUMINATION DEVICE AND DISPLAY DEVICE

(71) Applicant: SHARP KABUSHIKI KAISHA, Osaka-shi, Osaka (JP)

(72) Inventors: Ryoh Araki, Osaka (JP); Shigenori Tanaka, Osaka (JP); Kazuya Hatta, Yonago-shi (JP)

(21) Appl. No.: 14/434,215

(22) PCT Filed: Oct. 11, 2013
(86) PCT No.: PCT/JP2013/077714

§ 371 Date: Apr. 8, 2015

(30) Foreign Application Priority Data
Oct. 18, 2012 (JP) 2012-230738

(51) Int. Cl. F21V 8/00

(52) U.S. Cl. CPC G02B 6/0031; G02B 6/0091; G02B 6/0068; G02B 6/005; G02B 6/0021

(57) ABSTRACT

The present invention provides an illumination device that is provided with: a flexible substrate having an overlapping portion that contacts the light-receiving face side of the light-exiting surface of a light guide plate and in which substrate recesses and substrate protrusions are formed; a plurality of side-illumination type LEDs mounted in a line on the flexible substrate, with the LEDs facing the substrate recesses and the spaces between adjacent LEDs facing the substrate protrusions; first light-incident portions provided in positions that overlap the interior regions of the substrate recesses and at which light, having been emitted from the LEDs towards the portions of the light-receiving face that face the LEDs, arrives; and second light-incident portions that have a higher optical reflectance than the first light-incident portions and are provided on a surface that faces the LED-side of the substrate protrusions and at which light, having been emitted from the LEDs towards the portions of the light-receiving face that face the spaces between adjacent LEDs, arrives.

### TECHNICAL FIELD

The present invention relates to an illumination device and a display device.

### BACKGROUND ART

Many electronic devices such as computers as well as mobile computing devices such as mobile telephones, smartphones, and tablet computers are equipped with a display panel such as a liquid crystal panel. Many of the liquid crystal panels used in these display devices are not self-luminescent, and therefore a backlight must be provided separately as an illumination device. Backlight devices are typically classified as either direct-lit or edge-lit depending on the lighting mechanism employed. Edge-lit backlight devices are regarded as preferable in many applications because that one layer of the overall liquid crystal display device can be made thinner.

In edge-lit backlight devices, the chassis of the device houses a light guide plate that takes light emitted from a light source such as light-emitting diodes (LEDs) and guides that light to a light-exiting surface provided by one surface of the light guide plate. A light-receiving face is provided along at least one end face of the light guide plate, and an LED light source or the like is positioned facing the light-receiving face of the light guide plate. Particularly in the types of small computing devices and other electronic devices mentioned above, a flexible substrate is provided as an LED substrate on one surface of the light guide plate. A plurality of so-called side-illumination type LEDs, in which one side of each LED serves as the light-emitting surface thereof, are mounted on one side of the LED substrate. Patent Document 1 discloses one example of a backlight device of this type.

### RELATED ART DOCUMENT

### Patent Document

Patent Document 1: Japanese Patent Application Laid-Open Publication No. 2007-293084

### PROBLEMS TO BE SOLVED BY THE INVENTION

However, in edge-lit backlight devices equipped with a side-illumination type light source (such as the one disclosed in Patent Document 1), if a plurality of LEDs are used as the light source, each LED must be positioned close to the light-receiving face of the light guide plate, and the plurality of LEDs must be arranged in a line that runs parallel to the light-receiving face. In such a configuration, along the light-receiving face of the light guide plate, the distance from the LEDs to the light-receiving face is greater for the portions that face the spaces between adjacent LEDs than for the portions that face each LED. As a result, when viewing the light-receiving face side of the light-exiting surface of the light guide plate, the portions that face each LED appear brighter than the portions that face the spaces between adjacent LEDs. Similarly, the portions that face the spaces between adjacent LEDs appear darker than the portions that face each LED. This results in irregular brightness, with an alternating pattern of bright portions and dark portions along the light-receiving face side of the light-exiting surface of the light guide plate.

### SUMMARY OF THE INVENTION

The technology disclosed in the present specification was developed in view of such problems. The present invention aims to provide a technology that makes it possible to easily reduce or prevent irregularities in brightness along the light-receiving face-side of a light guide plate in an illumination device provided with a side-illumination type light source.

### Means for Solving the Problems

The technology disclosed in the present specification relates to an illumination device, including: a light guide plate having a light-exiting surface on one surface thereof, an opposite surface on another surface thereof, and a light-receiving face on at least one end face thereof; a light source substrate having: an overlapping portion disposed so as to overlap and contact one end of either the light-exiting surface or the opposite surface adjacent to the light-receiving face in a plan view; recesses formed in the overlapping portion and opened towards a center of the light guide plate; and protrusions formed on the overlapping portion and protruding towards the center of the light guide plate, the recesses and protrusions being alternately arranged parallel to the light-receiving face of the light guide plate; and a plurality of side-illumination type light sources that are arranged parallel to one another on the light source substrate along the light-receiving face of the light guide plate such that light-emitting surfaces of the light sources oppose the light-receiving face, the plurality of light sources being arranged so as to respectively face one of either the recesses or the protrusions of the light source substrate and such that gaps between the adjacent light sources face the other of either the recesses or the protrusions of the light source substrate, a first light-incident portion that is disposed at one of either a position overlapping an inner area of the recesses in a plan view or a surface of the protrusions facing the light sources, such that light emitted from the light sources and traveling to a location on the light-receiving face opposing the light sources in a plan view arrives at the first light-incident portion, and a second light-incident portion that is disposed at the other of either the position overlapping the inner area of the recesses in a plan view or the surface of the protrusions facing the light sources, such that light emitted from the light sources and traveling to a location on the light-receiving face opposing the gaps between the adjacent light sources arrives at the second light-incident portion, the second-light incident portion having a higher light reflectance than the first light-incident portion.

In edge-lit illumination devices, along the light-receiving face side of the light-exiting surface of the light guide plate, the distance from the light sources to the light-receiving face is greater for the portions that face the spaces between adjacent light sources than for the portions that face each light source. Therefore, usually the portions that face the spaces between adjacent light sources appear darker than the portions that face each light source. In the illumination device described above, a treatment is applied that causes the positions that overlap the interior of the substrate recesses in a plan view to exhibit a different optical reflectance than the surfaces that face the light source side of the substrate protrusions. This facilitates making the optical reflectance of the second light-incident portions higher than the optical reflectance of the first light-incident portions. Furthermore, when light emitted from the light sources reaches the first light-incident portions and the second light-incident portions, the second light-incident portions reflect more of the light than do the first light-incident portions because the second light-incident portions have a higher optical reflectance than the first light-incident portions. In this case, when viewing the light-receiving face side of the light-exiting surface of the light guide plate, the portions that overlap with the second light-incident portions in a plan view will appear brighter than the portions that overlap the first light-incident portions in a plan view because the second light-incident portions reflect more light. Meanwhile, the portions that overlap with the first light-incident portions in a plan view will appear darker than the portions that overlap the second light-incident portions in a plan view because the first light-incident portions reflect less light (that is, the first light-incident portions block more light). In other words, along the light-receiving face side of the light-exiting surface of the light guide plate, the portions that face the spaces between adjacent light sources are illuminated brightly, and the portions that face the light-emitting sides of the light sources are illuminated less brightly. This results in a smaller difference in brightness between the portions that face the light-emitting sides of the light sources and the portions that face the spaces between adjacent light sources along the light-receiving face side of the light-exiting surface of the light guide plate. Therefore, the brightness along the light-receiving face side of the light-exiting surface of the light guide plate can be made approximately uniform simply by changing the shape of the edge of the light source substrate. As described above, the present invention makes it possible to easily reduce or prevent irregularities in brightness along the light-receiving face side of the light-exiting surface of the light guide plate in an illumination device provided with a side-illumination type light source.

The first light-incident portion may be a light-shielding portion to which a light-shielding treatment has been applied, and the second light-incident portion may be a light-reflecting portion to which a light-reflecting treatment has been applied.

In this case, light that reaches the first light-incident portions (light-shielding portions) is blocked, and light that reaches the second light-incident portions (light-reflecting portions) is reflected. Therefore, the second light-incident portions exhibit higher optical reflectance than the first light-incident portions.

The illumination device may further include: a light-exiting surface sheet arranged on a surface of the light source substrate opposite to a surface where the light sources are disposed and partially overlapping the inner area of the recesses in a plan view, the light-exiting surface sheet having at least a surface facing the light source substrate being a light-shielding color, wherein the light source substrate has at least the protrusions thereon being a light-reflecting color, the light source substrate being arranged such that the recesses therein face the respective light sources in a plan view and the protrusions thereon face the respective gaps between the adjacent light sources in a plan view, and such that the overlapping portion of the light source substrate contacts an end of the light-exiting surface of the light guide plate near the light-receiving face thereof.

In this configuration, of the light emitted from the light sources, the light that proceeds towards the portions of the light-receiving face that face the light-emitting surfaces of the light sources in a plan view arrives at one of the light-exiting surface sheets, and the light that proceeds towards the portions of the light-receiving face that face the spaces between adjacent light sources in a plan view arrives at the substrate protrusions of the light source substrate. In other words, one of the light-exiting surface sheets is the first light-incident portion (light-shielding portion), and the substrate protrusions of the light source substrate are the second light-incident portions (light-reflecting portions). The light that arrives at the light-exiting surface sheets is blocked thereby, and the light that arrives at the substrate protrusions is reflected thereby. As a result, the brightness along the light-receiving face side of the light-emitting surface of the light guide plate is approximately uniform, and therefore, irregularities in brightness along that light-receiving face side of the light-emitting surface of the light guide plate can be reduced or prevented.

The illumination device may further include: a light-exiting surface sheet arranged on a surface of the light source substrate opposite to a surface where the light sources are disposed and partially overlapping the inner area of the recesses in a plan view, at least a surface facing the light source substrate of the light-exiting surface sheet being a light-reflecting color, wherein the light source substrate has at least the protrusions thereon being a light-shielding color, the light source substrate being arranged such that the recesses therein face the respective gaps between the adjacent light sources in a plan view and the protrusions thereon face the respective light sources in a plan view, and such that the overlapping portion of the light source substrate contacts an end of the light-exiting surface of the light guide plate near the light-receiving face thereof.

In this configuration, of the light emitted from the light sources, the light that proceeds towards the portions of the light-receiving face that face the light-emitting surfaces of the light sources in a plan view arrives at the substrate protrusions of the light source substrate, and the light that proceeds towards the portions of the light-receiving face that face the spaces between adjacent light sources in a plan view arrives at one of the light-exiting surface sheets. In other words, the substrate protrusions of the light source substrate are the first light-incident portions (light-shielding portions), and one of the light-exiting surface sheets is the second light-incident portion (light-reflecting portion). The light that arrives at the substrate protrusions is blocked thereby, and the light that arrives at the light-exiting surface sheets is reflected thereby. As a result, the brightness along the light-receiving face side of the light-emitting surface of the light guide plate is approximately uniform, and therefore, irregularities in brightness along that light-receiving face side of the light-emitting surface of the light guide plate can be reduced or prevented.

The illumination device may further include: an optical sheet in contact with the light-exiting surface of the light guide plate and that exerts an optical effect on light that has exited therefrom, the optical sheet having recesses formed in an end thereof near the light-receiving face of the light guide plate and opened towards the light sources, and protrusions formed in an end thereof near the light-receiving face of the light guide plate and protruding towards the light sources, the recesses and protrusions being alternately arranged parallel to the light-receiving face of the light guide plate and at least the protrusions being a light-shielding color, wherein the light source substrate has at least the protrusions thereon being a light-reflecting color, the light source substrate being arranged such that the recesses therein face the respective light sources in a plan view and the protrusions thereon face the respective gaps between the adjacent light sources in a plan view, and such that the overlapping portion of the light source substrate contacts an end of the light-exiting surface of the light guide plate near the light-receiving face thereof, and wherein the optical sheet and the light source substrate are arranged such that the protrusions on the optical sheet engage the recesses in the light source substrate, and the protrusions on the light source substrate engage the recesses in the optical sheet.

In this configuration, of the light emitted from the light sources, the light that proceeds towards the portions of the light-receiving face that face the light-emitting surfaces of the light sources in a plan view arrives at the optical sheet protrusions of the optical sheet, and the light that proceeds towards the portions of the light-receiving face that face the spaces between adjacent light sources in a plan view arrives at the substrate protrusions of the light source substrate. In other words, the optical sheet protrusions of the optical sheet are the first light-incident portions (light-shielding portions), and the substrate protrusions of the light source substrate are the second light-incident portions (light-reflecting portions). The light that arrives at the optical sheet protrusions is blocked thereby, and the light that arrives at the substrate protrusions is reflected thereby. As a result, the brightness along the light-receiving face side of the light-exiting surface of the light guide plate is approximately uniform, and therefore, irregularities in brightness along that light-receiving face side of the light-emitting surface of the light guide plate can be reduced or prevented.

The illumination device may further include: an optical sheet in contact with the light-exiting surface of the light guide plate and that exerts an optical effect on light that has exited therefrom, the optical sheet having recesses formed in an end thereof near the light-receiving face of the light guide plate and opened towards the light sources, and protrusions formed in an end thereof near the light-receiving face of the light guide plate and protruding towards the light sources, the recesses and protrusions being alternately arranged parallel to the light-receiving face of the light guide plate and at least the protrusions being a light-shielding color, wherein the light source substrate has at least the protrusions thereon being a light-reflecting color, the light source substrate being arranged such that the recesses therein face the respective gaps between the adjacent light sources in a plan view and the protrusions thereon face the respective light sources in a plan view, and such that the overlapping portion of the light source substrate contacts an end of the light-exiting surface of the light guide plate near the light-receiving face thereof, and wherein the optical sheet and the light source substrate are arranged such that the protrusions on the optical sheet engage the recesses in the light source substrate, and the protrusions on the light source substrate engage the recesses in the optical sheet.

In this configuration, of the light emitted from the light sources, the light that proceeds towards the portions of the light-receiving face that face the light-exiting surfaces of the light sources in a plan view arrives at the substrate protrusions of the light source substrate, and the light that proceeds towards the portions of the light-receiving face that face the spaces between adjacent light sources in a plan view arrives at the optical sheet protrusions of the optical sheet. In other words, the substrate protrusions of the light source substrate are the first light-incident portions (light-shielding portions), and the optical sheet protrusions of the optical sheet are the second light-incident portions (light-reflecting portions). The light that arrives at the substrate protrusions is blocked thereby, and the light that arrives at the optical sheet protrusions is reflected thereby. As a result, the brightness along the light-receiving face side of the light-exiting surface of the light guide plate is approximately uniform, and therefore, irregularities in brightness along that light-receiving face side of the light-exiting surface of the light guide plate can be reduced or prevented.

The illumination device may further include: a reflective sheet in contact with the opposite surface of the light guide plate and that reflects light that has leaked from the opposite surface back toward the light guide plate, the reflective sheet having recesses formed in an end thereof near the light-receiving face of the light guide plate and opened towards the light sources, and protrusions formed in an end thereof near the light-receiving face of the light guide plate and protruding towards the light sources, the recesses and protrusions being alternately arranged parallel to the light-receiving face of the light guide plate and at least the protrusions being a light-shielding color, wherein the light source substrate has at least the protrusions thereon being a light-reflecting color, the light source substrate being arranged such that the recesses therein face the respective light sources in a plan view and the protrusions thereon face the respective gaps between the adjacent light sources in a plan view, and such that the overlapping portion of the light source substrate contacts an end of the opposite surface of the light guide plate near the light-receiving face thereof, and wherein the reflective sheet and the light source substrate are arranged such that the protrusions on the reflective sheet engage the recesses in the light source substrate, and the protrusions on the light source substrate engage the recesses in the reflective sheet.

In this configuration, of the light emitted from the light sources, the light that proceeds towards the portions of the light-receiving face that face the light-exiting surfaces of the light sources in a plan view arrives at the reflective sheet protrusions of the reflective sheet, and the light that proceeds towards the portions of the light-receiving face that face the spaces between adjacent light sources in a plan view arrives at the substrate protrusions of the light source substrate. In other words, the reflective sheet protrusions of the reflective sheet are the first light-incident portions (light-shielding portions), and the substrate protrusions of the light source substrate are the second light-incident portions (light-reflecting portions). The light that arrives at the reflective sheet protrusions is blocked thereby, and the light that arrives at the substrate protrusions is reflected thereby. As a result, the brightness along the light-receiving face side of the light-exiting surface of the light guide plate is approximately uniform, and therefore, irregularities in brightness along that light-receiving face side of the light-exiting surface of the light guide plate can be reduced or prevented.

The illumination device may further include: a reflective sheet in contact with the opposite surface of the light guide plate and that reflects light that has leaked from the opposite surface back toward the light guide plate, the reflective sheet having recesses formed in an end thereof near the light-receiving face of the light guide plate and opened towards the light sources, and protrusions formed in an end thereof near the light-receiving face of the light guide plate and protruding towards the light sources, the recesses and protrusions being alternately arranged parallel to the light-receiving face of the light guide plate and at least the protrusions being a light-reflecting color, wherein the light source substrate has at least the protrusions thereon being a light-shielding color, the light source substrate being arranged such that the recesses therein face the respective gaps between the adjacent light sources in a plan view and the protrusions thereon face the respective light sources in a plan view, and such that the overlapping portion of the light source substrate contacts an end of the light-exiting surface of the light guide plate near the light-receiving face thereof, and wherein the reflective sheet and the light source substrate are arranged such that the protrusions on the reflective sheet engage the recesses in the light source substrate, and the protrusions on the light source substrate engage the recesses in the reflective sheet.

In this configuration, of the light emitted from the light sources, the light that proceeds towards the portions of the light-receiving face that face the light-emitting surfaces of the light sources in a plan view arrives at the substrate protrusions of the light source substrate, and the light that proceeds towards the portions of the light-receiving face that face the spaces between adjacent light sources in a plan view arrives at the reflective sheet protrusions of the reflective sheet. In other words, the substrate protrusions of the light source substrate are the first light-incident portions (light-shielding portions), and the reflective sheet protrusions of the reflective sheet are the second light-incident portions (light-reflecting portions). The light that arrives at the substrate protrusions is blocked thereby, and the light that arrives at the reflective sheet protrusions is reflected thereby. As a result, the brightness along the light-receiving face side of the light-exiting surface of the light guide plate is approximately uniform, and therefore, irregularities in brightness along that light-receiving face side of the light-exiting surface of the light guide plate can be reduced or prevented.

The illumination device may further include: a support member on a side of the light guide plate opposite to the light-exiting surface thereof having at least a support surface along the opposite surface for supporting a side of the light source substrate opposite to a side on which the light sources are arranged, the support member having a light-shielding color at a location on the support surface thereof overlapping inner area of the recesses in the light source substrate in a plan view, wherein the light source substrate has at least the protrusions thereon being a light-reflecting color, the light source substrate being arranged such that the recesses therein face the respective gaps between the adjacent light sources in a plan view and the protrusions thereon face the respective light sources in a plan view, and such that the overlapping portion of the light source substrate contacts an end of the light-exiting surface of the light guide plate near the light-receiving face thereof.

In this configuration, of the light emitted from the light sources, the light that proceeds towards the portions of the light-receiving face that face the light-emitting surfaces of the light sources in a plan view arrives at the portions of the supporting surface that overlap with the interior regions of the substrate recesses in a plan view, and the light that proceeds towards the portions of the light-receiving face that face the spaces between adjacent light sources in a plan view arrives at the substrate protrusions of the light source substrate. In other words, the portions of the supporting surface that overlap with the interior regions of the substrate recesses are the first light-incident portions (light-shielding portions), and the substrate protrusions of the light source substrate are the second light-incident portions (light-reflecting portions). The light that arrives at the portions of the supporting surface that overlap with the interior regions of the substrate recesses is blocked, and the light that arrives at the substrate protrusions is reflected thereby. As a result, the brightness along the light-receiving face side of the light-exiting surface of the light guide plate is approximately uniform, and therefore, irregularities in brightness along that light-receiving face side of the light-exiting surface of the light guide plate can be reduced or prevented.

The illumination device may further include: a support member on a side of the light guide plate opposite to the light-exiting surface thereof having at least a support surface along the opposite surface for supporting a side of the light source substrate opposite to a side on which the light sources are arranged, the support member having a light-reflecting color at a location on the support surface thereof overlapping inner area of the recesses in the light source substrate in a plan view, wherein the light source substrate has at least the protrusions thereon being a light-reflecting color, the light source substrate being arranged such that the recesses therein face the respective gaps between the adjacent light sources in a plan view and the protrusions thereon face the respective light sources in a plan view, and such that the overlapping portion of the light source substrate contacts an end of the light-exiting surface of the light guide plate near the light-receiving face thereof.

In this configuration, of the light emitted from the light sources, the light that proceeds towards the portions of the light-receiving face that face the light-emitting surfaces of the light sources in a plan view arrives at the substrate protrusions of the light source substrate, and the light that proceeds towards the portions of the light-receiving face that face the spaces between adjacent light sources in a plan view arrives at the portions of the supporting surface that overlap with the interior regions of the substrate recesses in a plan view. In other words, the substrate protrusions of the light source substrate are the first light-incident portions (light-shielding portions), and the portions of the supporting surface that overlap with the interior regions of the substrate recesses are the second light-incident portion (light-reflecting portion). The light that arrives at the substrate protrusions is blocked thereby, and the light that arrives at the portions of the supporting surface that overlap with the interior regions of the substrate recesses is reflected. As a result, the brightness along the light-receiving face side of the light-exiting surface of the light guide plate is approximately uniform, and therefore, irregularities in brightness along that light-receiving face side of the light-exiting surface of the light guide plate can be reduced or prevented.

A degree of recess in the light source substrate and a degree of protrusion on the light source substrate at both ends on the overlapping portion on the light guide plate in an arrangement direction of the light sources may be greater than a degree of recess in the light source substrate and a degree of protrusion on the light source substrate at other locations.

In this configuration, along the light-receiving face side of the light-exiting surface of the light guide plate, the amount of light that is blocked by the first light-incident portions that are provided on both ends of the light source substrate in the direction in which the light sources are aligned (that is, in the direction parallel to the light-receiving face) is larger than the amount of light that is blocked by the first light-incident portions that are formed in other portions of the light source substrate. Similarly, the amount of light that is reflected by the second light-incident portions that are provided on both ends of the light source substrate in the direction in which the light sources are aligned is larger than the amount of light that is reflected by the second light-incident portions that are formed in other portions of the light source substrate. As a result, if portions of the light-exiting surface of the light guide plate are patterned to create light guide plate patterns (printed patterns), for example, the brightness along the light-receiving face side of the light-exiting surface of the light guide plate can still be adjusted to be approximately uniform even if the pattern used on both lengthwise ends of the light-receiving face side of the light-exiting surface of the light guide plate (where the lengthwise direction is parallel to the line along which the light sources are mounted) creates more distinctive areas of brightness and darkness than the pattern used in other portions along that edge. Moreover, irregularities in brightness along that light-receiving face side of the light-exiting surface of the light guide plate can still be reduced or prevented.

The light-reflecting color may be white, and the light-shielding color may be black.

This allows a specific light reflection treatment and a specific light-shielding (light-absorbing) treatment to be provided.

The light source substrate may be a flexible substrate, and each of the plurality of light sources may be arranged such that a light-emitting surface thereof is near the light-receiving face of the light guide plate.

This configuration provides a small edge-lit module or the like in which side-illumination type light sources are mounted on a flexible substrate and positioned near a light guide plate. This configuration can reduce or prevent irregularities in brightness along the light-receiving face side of the light-exiting surface of the light guide plate.

The technology disclosed in the present specification may be used to provide a display device, including: the abovementioned illumination device; and a display panel that display images using light from the illumination device. Moreover, a display device wherein the display panel is a liquid crystal panel including liquid crystal sealed between a pair of substrates has both inventive step and technical utility.

### Effects of the Invention

The technology disclosed in the present specification makes it possible to easily reduce or prevent irregularities in brightness along the light-receiving face side of a light guide plate in an illumination device provided with a side-illumination type light source.

### BRIEF DESCRIPTION OF THE DRAWINGS

FIG. 1 is an exploded perspective view of a liquid crystal display device 10 according to Embodiment 1.

FIG. 2 is a plan view illustrating the front of a backlight device 24.

FIG. 3 is an enlarged plan view illustrating the front of a flexible substrate 30.

FIG. 4 is a cross-sectional view of a cross section taken along line IV-IV in FIG. 3.

FIG. 5 is a cross-sectional view of a cross section taken along line V-V in FIG. 3.

FIG. 6 is an enlarged plan view illustrating the front of a flexible substrate 30 according to Modification Example 1 of Embodiment 1.

FIG. 7 is a cross-sectional view of a cross section taken along line VII-VII in FIG. 6.

FIG. 8 is a cross-sectional view of a cross section taken along line VIII-VIII in FIG. 6.

FIG. 9 is an enlarged plan view illustrating the front of a flexible substrate 30 according to Modification Example 2 of Embodiment 1.

FIG. 10 is an enlarged plan view illustrating the front of a flexible substrate 30 according to Modification Example 3 of Embodiment 1.

FIG. 11 is an enlarged plan view illustrating the front of a flexible substrate 30 according to Modification Example 4 of Embodiment 1.

FIG. 12 is an enlarged plan view illustrating the front of a flexible substrate 130 according to Embodiment 2.

FIG. 13 is a cross-sectional view of a cross section taken along line XIII-XIII in FIG. 12.

FIG. 14 is a cross-sectional view of a cross section taken along line XIV-XIV in FIG. 12.

FIG. 15 is an enlarged plan view illustrating the front of a flexible substrate 130 according to a modification example of Embodiment 2.

FIG. 16 is a cross-sectional view of a cross section taken along line XVI-XVI in FIG. 15.

FIG. 17 is a cross-sectional view of a cross section taken along line XVII-XVII in FIG. 15.

FIG. 18 is an exploded perspective view of a liquid crystal display device 210 according to Embodiment 3.

FIG. 19 is an enlarged plan view illustrating the front of a flexible substrate 230.

FIG. 20 is a cross-sectional view of a cross section taken along line XX-XX in FIG. 19.

FIG. 21 is a cross-sectional view of a cross section taken along line XXI-XXI in FIG. 19.

FIG. 22 is an enlarged plan view illustrating the front of a flexible substrate 230 according to a modification example of Embodiment 3.

FIG. 23 is a cross-sectional view of a cross section taken along line XXIII-XXIII in FIG. 22.

FIG. 24 is a cross-sectional view of a cross section taken along line XXI-VXIV in FIG. 22.

FIG. 25 is an exploded perspective view of a liquid crystal display device 310 according to Embodiment 4.

FIG. 26 is an enlarged plan view illustrating the front of a flexible substrate 330.

FIG. 27 is a cross-sectional view of a cross section taken along line XXVII-XXVII in FIG. 26.

FIG. 28 is an enlarged plan view illustrating the front of a flexible substrate 330 according to Modification Example 1 of Embodiment 4.

FIG. 29 is a cross-sectional view of a cross section taken along line XXIX-XXIX in FIG. 28.

FIG. 30 is a cross-sectional view of Modification Example 2 of Embodiment 4 that corresponds to the cross-sectional view shown in FIG. 27.

FIG. 31 is a cross-sectional view of Modification Example 3 of Embodiment 4 that corresponds to the cross-sectional view shown in FIG. 27.

### DETAILED DESCRIPTION OF EMBODIMENTS

### Embodiment 1

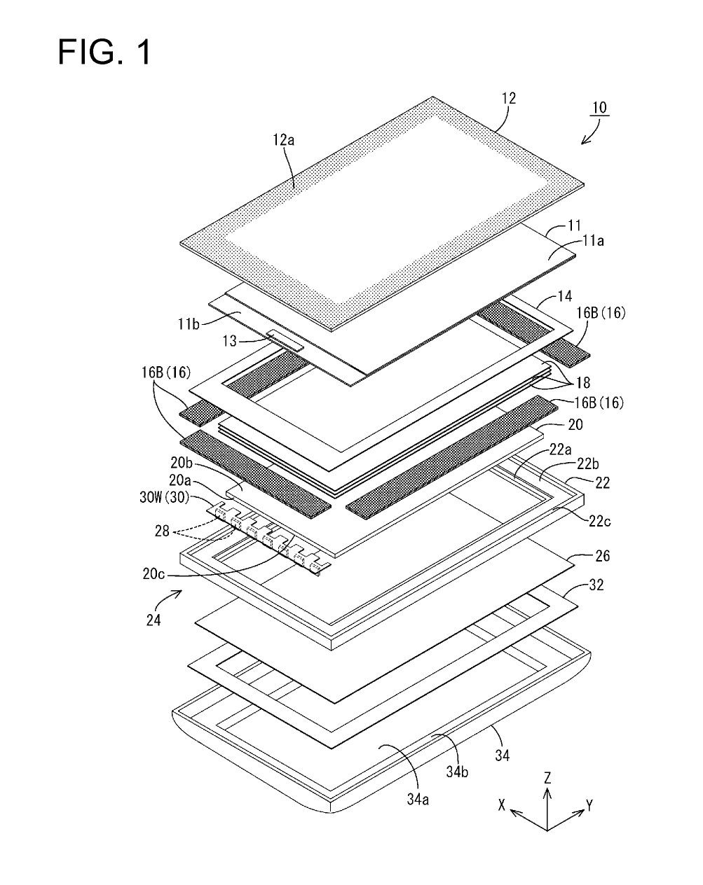

Embodiment 1 will be described below with reference to figures. The present embodiment is an example of a liquid crystal display device 10 equipped with a cover panel 12. X, Y, and Z coordinate axes are provided in each figure and point in the directions shown. Moreover, the “up” and “down” directions are defined as shown in figures such as FIGS. 1, 4, and 5 (that is, in the positive and negative Z directions, respectively). Based on these definitions of the up and down directions, the “front side” of a component depicted in the figures refers to the upper side of that component, and similarly, the “rear side” of a component refers to the lower side of that component.

As shown in FIG. 1, the overall liquid crystal display device 10 has an elongated rectangular shape. The liquid crystal display device 10 includes: a liquid crystal panel 11 (an example of a display panel) having, on the front side of the panel, a display surface for displaying images; a cover panel 12 that faces the display surface of the liquid crystal panel 11; and a backlight device 24 (an example of an illumination device) that serves as an external light source for providing light to the liquid crystal panel 11 and is provided on the side of the liquid crystal panel 11 opposite to the side on which the cover panel 12 is disposed, resulting in the liquid crystal panel 11 being sandwiched between the cover panel 12 and the backlight device 24. Furthermore, the liquid crystal display device 10 includes a casing 34 that houses the following components: the cover panel 12, the liquid crystal panel 11, and the backlight device 24. The cover panel 12 and casing 34 together form the exterior of the liquid crystal display device 10. The liquid crystal display device 10 according to the present embodiment is suitable for use in electronic devices such as mobile computing devices (mobile telephones, smartphones, tablet computers, and the like), on-vehicle computing devices (built-in car navigation systems, portable car navigation systems, and the like), or mobile gaming devices. Therefore, the size of the liquid crystal panel 11 and the cover panel 12 of the liquid crystal display device 10 (the screen size) can be set somewhere in the range from several inches to approximately 10 inches; that is, to a size at which the liquid crystal display device 10 would typically be classified as a small- to mid-sized device.

First, the liquid crystal panel 11 will be described. As shown in FIG. 1, the overall liquid crystal panel 11 has an elongated rectangular shape. The liquid crystal panel 11 includes: a pair of transparent glass substrates 11a and 11b; and a liquid crystal layer (not shown in the figure) that is sandwiched between the substrates 11a and 11b and contains a liquid crystal material having optical characteristics that change according to the application of an electric field. The substrates 11a and 11b are fixed to one another with a prescribed gap equal to the thickness of the liquid crystal layer left therebetween using a sealing agent (not shown in the figure). The substrate on the front side is the color filter substrate 11a, and the substrate on the rear side is the array substrate 11b. Provided on the array substrate 11b are switching elements (such as TFTs) connected to source lines and gate lines that are mutually orthogonal, pixel electrodes that are connected to those switching elements, an alignment film, and the like. Provided on the color filter substrate 11a is a color filter having colored portions in colors such as red, green, and blue that are arranged in a prescribed pattern; an opposite electrode; an alignment film, and the like. As shown in FIG. 1, while the short side of the color filter substrate 11a is approximately equal in length to the short side of the array substrate 11b, the long side of the color filter substrate 11a is shorter than the long side of the array substrate 11b. Moreover, the color filter substrate 11a and the array substrate 11b are fixed to one another such that the short sides thereof are aligned on one lengthwise end. As a result, on the other lengthwise end, both the front and rear surfaces of the array substrate 11b are exposed. This exposed region can be used to mount either a driver 13 for driving the liquid crystal panel 11 or a panel-side flexible substrate (not shown in the figure). This configuration allows the image data and control signals necessary for displaying an image to be sent from a drive circuit board (not shown in the figure) to the source lines, gate line, opposite electrode, and the like. Finally, polarizing plates (not shown in the figure) are provided on the outer-facing surfaces of both substrates.

The cover panel 12 is shaped such that it covers the entire front side of the liquid crystal panel 11 and can protect the liquid crystal panel 11. An adhesive agent (not shown in the figure) is applied in the center region of the rear side of the cover panel 12 to fix the cover panel 12 to the liquid crystal panel 11. Similar to the liquid crystal panel 11, the cover panel 12 has an elongated rectangular shape. When viewed in a plan view, the cover panel 12 is larger than the substrates 11a and 11b of the liquid crystal panel 11 in both dimensions and approximately equal in size to the outer periphery of a frame 22 (described below). Accordingly, the outer periphery portion of the cover panel 12 extends out (overhangs) over the outer edges of the liquid crystal panel 11. A light-shielding portion 12a is formed around the outer periphery of the cover panel 12. The light-shielding portion 12a can be formed using a printing method such as screen printing or inkjet printing, for example. The light-shielding portion 12a is also formed on the portion of the cover panel 12 that extends out (overhangs) over the outer edges of the liquid crystal panel 11 such that the light-shielding portion 12a is formed in an elongated frame shape. This prevents light from the backlight device 24 from entering the cover panel 12 in the region on the rear surface thereof that runs around the periphery of the liquid crystal panel 11.

The casing 34 can be made from a synthetic resin material or a metal material. As shown in FIG. 1, the casing 34 is generally bowl-shaped and opens towards the front side. The cover panel 12, the liquid crystal panel 11, and the backlight device 24 are housed within the housing space inside the casing 34. As a result, the casing 34 covers the rear side of the backlight device 24. The casing 34 also covers the sides of the backlight device 24 and the cover panel 12 around the entire periphery thereof. The casing 34 therefore forms the exterior of the liquid crystal display device 10 on the rear side and lateral sides thereof. Moreover, the periphery of the casing 34 is generally stair-shaped and has two levels: a lowest first level portion 34a and a second lowest second level portion 34b. Within the casing 34, a casing adhesive tape 32 that adheres to both the rear surface of the frame 22 of the backlight device 24 and the second level portion 34b that faces the frame 22 is arranged therebetween. This casing adhesive tape 32 fixes the casing 34 and the frame 22 to one another. The casing adhesive tape 32 has a generally elongated frame shape to match the shape of the frame 22 to which the casing adhesive tape 32 will adhere, and therefore the casing 34 and the frame 22 are fixed to one another around essentially the entire periphery thereof. A part of the casing adhesive tape 32 is also adhered to the outer peripheral edge of a reflective sheet 26 (described below). Moreover, the casing adhesive tape 32 includes a flexible tape-shaped base material and an adhesive agent that is applied to both the front and rear surfaces of the base material. Moreover, the remaining space between the first level portion 34a and the rear side of the backlight device 24 houses various components that are not shown in the figure such as a control circuit board for controlling how the liquid crystal panel 11 is driven and an LED drive circuit board for supplying power to drive LEDs 28 (described below).

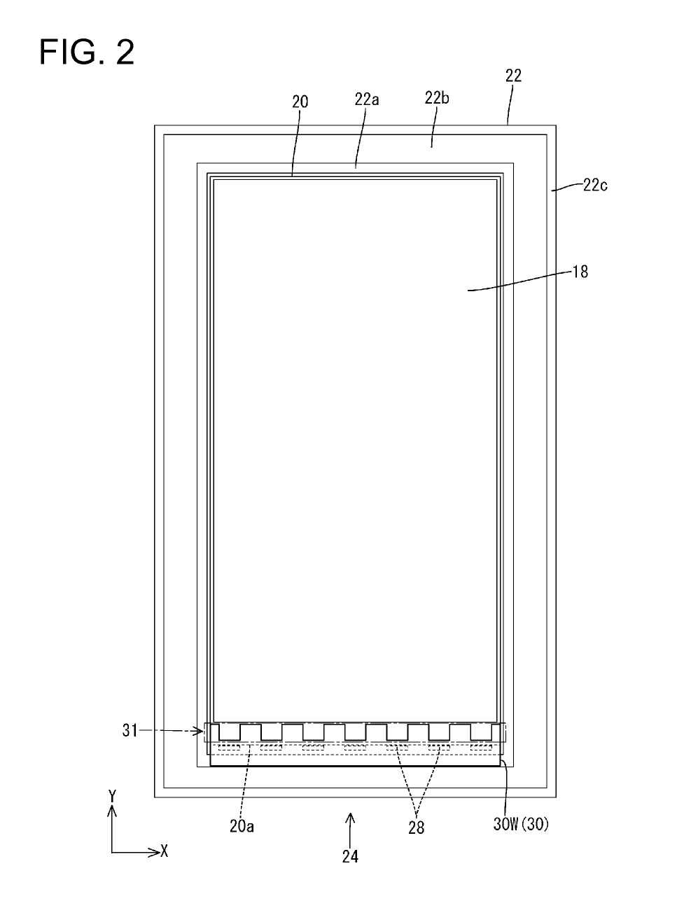

Next, the backlight device 24 will be described. The backlight device 24 includes: light-emitting diodes (LEDs) 28 that serve as the light source; a flexible substrate 30 (an example of a light source substrate) on which the LEDs 28 are mounted; a light guide plate 20 that guides light emitted from the LEDs 28; an optical sheet 18 that is layered on top of the light guide plate 20; four light-exiting surface sheets 16 that are each layered on top of the optical sheet 18 around the outer peripheral edges thereof; the reflective sheet 26 that is layered beneath the light guide plate 20; and the frame-shaped frame 22 that encloses the light guide plate 20 and the optical sheet 18 and also holds the light-exiting surface sheets 16 and the liquid crystal panel 11 from the rear sides thereof (that is, from the sides opposite to the side on which the cover panel 12 is disposed). It should be noted that in FIG. 2, the light-exiting surface sheets 16 are not shown. The backlight device 24 is a so-called edge-lit (side-lit) backlight device in which the LEDs 28 are arranged along the ends of the periphery of the liquid crystal panel 11. Next, each of the components of the backlight device 24 will be described.

As shown in FIG. 2, similar to the liquid crystal panel 11, the optical sheet 18 has an elongated rectangular shape when viewed in a plan view. The optical sheet 18 is smaller than the light guide plate 20 in both the X and Y dimensions. The optical sheet 18 is arranged between the liquid crystal panel 11 and the light guide plate 20 such that the optical sheet 18 fits entirely on the front side (the light-emitting side) of the light guide plate 20. The optical sheet 18 transmits light emitted from the light guide plate 20 towards the liquid crystal panel 11 and also applies a prescribed optical effect to that transmitted light. The optical sheet 18 includes a plurality of sheet-shaped members that are layered on top of one another. Specific examples of the optical sheet 18 include a diffusion sheet, a lens sheet, and a reflective polarizing sheet, for example. The optical sheet to use can be selected from among these examples as appropriate.

The light guide plate 20 is made from a synthetic resin material (such as an acrylic resin such as polymethyl methacrylate (PMMA) or a polycarbonate, for example) that has a refractive index that is sufficiently higher than that of air and is also substantially transparent (exhibits excellent transparency). As shown in FIG. 2, similar to the liquid crystal panel 11, the light guide plate 20 has an elongated rectangular shape when viewed in a plan view. The light guide plate 20 is plate-shaped and has a thickness greater than the thickness of the optical sheet 18. The short side of the surface of the light guide plate 20 is parallel to the X direction, and the long side of the surface of the light guide plate 20 is parallel to the Y direction. The thickness direction of the light guide plate 20 is parallel to the Z direction. As shown in FIGS. 1 and 2, the light guide plate 20 is enclosed by the frame 22 (described below) and positioned beneath the liquid crystal panel 11 and the optical sheet 18. As shown in FIGS. 1, 4, and 5, the front surface of the light guide plate 20 (the surface that faces the liquid crystal panel 11 and the optical sheet 18) is the light-exiting surface 20b. The light-exiting surface 20b emits light from inside the light guide plate 20 towards the optical sheet 18 and the liquid crystal panel 11. Meanwhile, the surface on the opposite side of the light-exiting surface 20b (that is, the rear surface of the light guide plate 20) is the opposite surface 20c. The end face of one of the edges of the light guide plate that are parallel to the X direction is the light-receiving face 20a. The light-receiving face 20a faces the LEDs 28 provided on the flexible substrate 30, as described below, and light emitted from the LEDs 28 enters the light guide plate 20 through the light-receiving face 20a. The light guide plate 20 takes the light emitted from each of the LEDs 28 and guides it away from the light-receiving face 20a, spreading that light throughout the interior of the light guide plate 20 and then emitting it from the light-exiting surface front surface 20b towards the optical sheet 18.

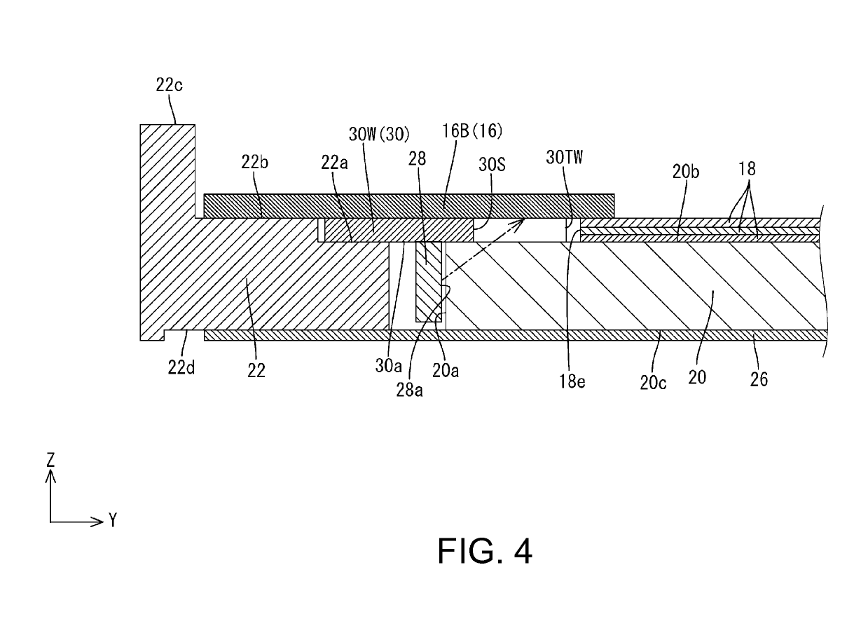

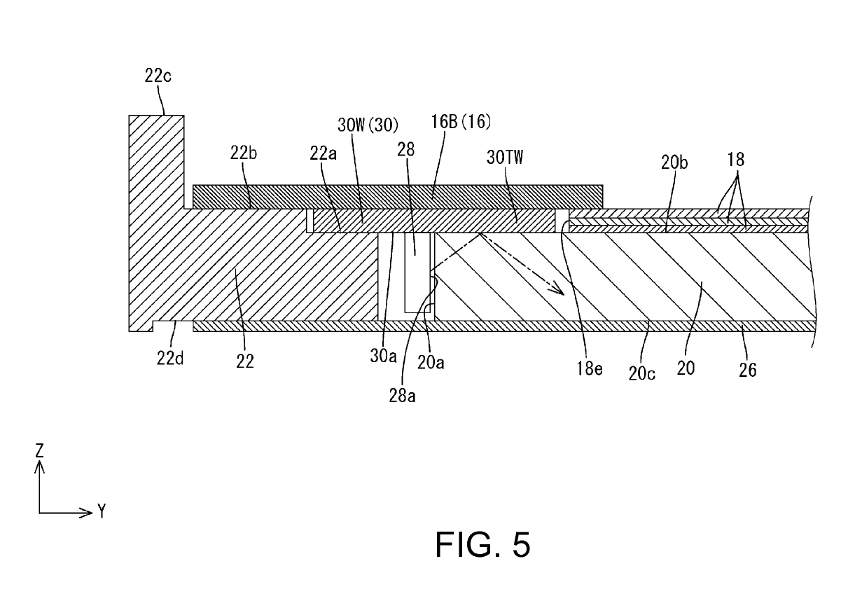

The majority of the reflective sheet 26 contacts the opposite surface 20c of the light guide plate 20. The outer peripheral edge of the front surface of the reflective sheet 26 contacts the rear side of the frame 22. As described above, the outer peripheral edge of the rear surface of the reflective sheet 26 is fixed to the second level portion 34b of the casing 34 via the casing adhesive tape 32. Both of the edges along the long sides of reflective sheet 26 (that is, the edges parallel to the Y direction) extend out (in the X direction) beyond both of the short side edges of the light guide plate 20. As shown in FIGS. 4 and 5, the reflective sheet 26 extends out and covers the space between the light-receiving face 20a and the LEDs 28 from the rear side. This extended portion of the reflective sheet 26 reflects light emitted from the LEDs 28 that goes towards the rear side (towards the reflective sheet 26). This increases the amount of light that enters the light-receiving face 20a. Moreover, a portion of either at least one of the light-exiting surface 20b and the opposite surface 20c of the light guide plate 20, or, the front surface of the reflective sheet 26, is patterned to create a diffusion portion (not shown in the figures) that diffuses light to create a prescribed in-plane distribution of light. This ensures that the light emitted from the light-exiting surface 20b has a uniform in-plane distribution.

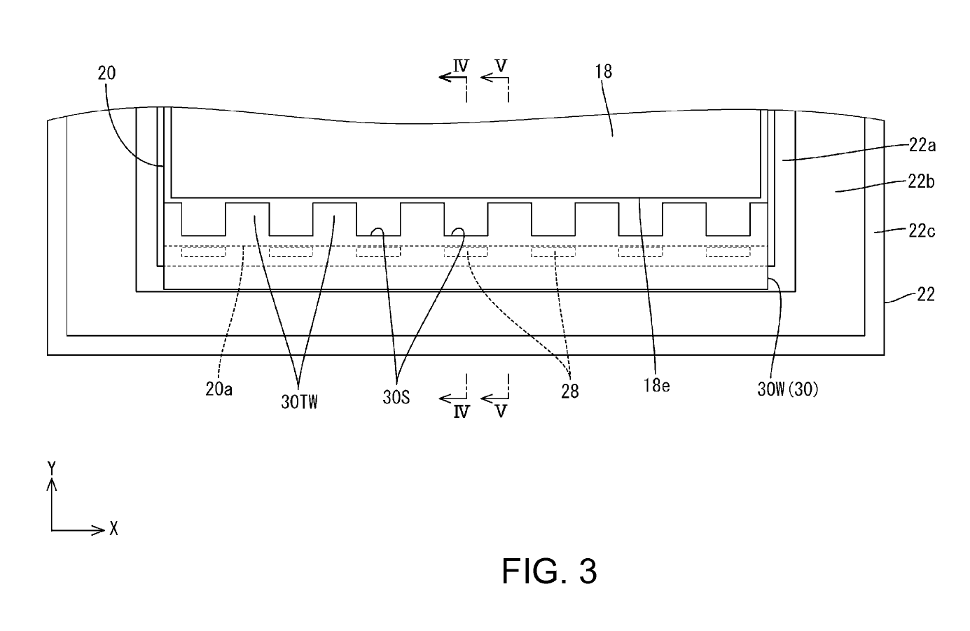

The flexible substrate 30 is formed using a film-shaped base material made from an insulating, flexible synthetic resin material (such as a polyimide resin, for example) and is positioned near the light-receiving face 20a side of the light guide plate 20. The flexible substrate 30 has an elongated rectangular shape when viewed in a plan view. The long sides of the flexible substrate 30 are parallel to the X direction, and the short sides of the flexible substrate 30 are parallel to the Y direction. The front surface of the flexible substrate 30 faces the liquid crystal panel 11. The rear surface of the flexible substrate 30 faces the optical sheet 26 and also forms the mounting surface 30a on which the LEDs 28 are mounted. One of the long edges of the flexible substrate 30 contacts the light-receiving face 20a side of the light-exiting surface 20b of the light guide plate 20 and overlaps with that edge when viewed in a plan view. Below, this overlapping portion of the flexible substrate 30 is referred to as the overlapping portion 31 (see FIG. 2). As a result, this long edge of the flexible substrate 30 faces the light-receiving face 20a side 18e of the optical sheet 18 (see FIG. 3). This long edge of the flexible substrate 30 is fixed to the light guide plate 20 via adhesive tape or the like (not shown in the figure) that is applied to the overlapping portion 31. The other long edge of the flexible substrate 30 is supported by the frame 22 by resting on the first level portion 22a thereof. It should be noted that in the present embodiment, a white color is applied to the surfaces of the flexible substrate 30 to increase the reflectivity thereof and form the reflective flexible substrate 30W.

On the mounting surface 30a of the flexible substrate 30, a plurality of LEDs 28 are mounted along a line that is parallel to the long sides of the flexible substrate 30 (that is, along a line that is parallel to the X direction). As shown in FIG. 3, each LED 28 is mounted on the mounting surface 30a of the flexible substrate 30 such that the light-emitting surface 28a of that LED 28 faces the light-receiving face 20a of the light guide plate 20. A portion of the long edge of the flexible substrate 30 that is supported by the frame 22 extends outward to form an extending portion (not shown in the figure). Connection terminals are provided along the edge of the extending portion and electrically connected to a power supply circuit board or the like (not shown in the figure) that powers the LEDs 28 and controls how the LEDs 28 are driven. Meanwhile, along the other long edge of the flexible substrate 30 that contacts the light-exiting surface 20b of the light guide plate 20 (that is, along the overlapping portion 31), substrate recesses 30S that open towards the center of the light guide plate 20 are formed, and substrate protrusions 30TW that protrude towards the center of the light guide plate 20 are formed. The substrate recesses 30S and the substrate protrusions 30TW are alternately arranged in the long side direction of the flexible substrate 30 (that is, in the direction that is parallel to the light-receiving face 20a). The configuration and effects of these substrate recesses 30S and substrate protrusions 30TW will be described in more detail later.

The plurality of LEDs 28 are mounted in a line on the mounting surface 30a of the flexible substrate 30. The LED chips (not shown in the figure) are sealed to the substrate portion of the flexible substrate 30 using a resin material. The LED chips mounted on the substrate portion primarily emit light of one wavelength. More specifically, LED chips that emit only blue light are used. Meanwhile, a fluorescent material that is excited by the blue light emitted from the LED chips and emits light of a prescribed color is dispersed in the resin material used to seal the LED chips. Overall, the LED chip-resin material assemblies emit primarily white light. It should be noted that an appropriate combination of a yellow fluorescent substance that emits yellow light, a green fluorescent substance that emits green light, and a red fluorescent substance that emits red light or any single one of these fluorescent substances can be used for the fluorescent material. These LEDs 28 are so-called side-illumination type LEDs in which one of the side surfaces of each of the LEDs is the light-emitting surface 28a (where the surfaces of the LEDs that are mounted to the flexible substrate 30 are the front (or rear) surfaces). As described above, the plurality of LEDs 28 are mounted on the mounting surface 30a of the flexible substrate 30 in a (straight) line that runs parallel to the long sides of the flexible substrate 30 (that is, parallel to the X direction), such that the light-emitting surface 28a of each LED 28 is near the light-receiving face 20a of the light guide plate 20 and such that a prescribed interval is left between each LED 28. In other words, the plurality of LEDs 28 are arranged in an intermittent manner along a line that runs parallel to the long sides of the flexible substrate 30 (that is, parallel to the X direction) on one end of the backlight device 24.

Each of the four light-exiting surface sheets 16 is arranged along one edge of the light guide plate 20, which has an elongated rectangular shape. The four light-exiting surface sheets 16 each cover one of the outer peripheral edges of the front side of the light guide plate 20 and are supported by the frame 22 by resting on the second level portion 22b thereof. As shown in FIGS. 4 and 5, the light-exiting surface sheet 16 that is on the light-receiving face 20a side of the light guide plate 20 rests on and covers the entire surface of the flexible substrate 30 that is opposite to the mounting surface 30a. Moreover, one edge of this light-exiting surface sheet 16 rests on the light-receiving face 20a side 18e of the optical sheet 18. In this way, the light-exiting surface sheet 16 that is on the light-receiving face 20a side of the light guide plate 20 covers the gap between the flexible substrate 30 and the optical sheet 18 from the front side. Moreover, each of the four light-exiting surface sheets 16 is slightly longer than the edge of the light guide plate 20 covered by that particular light-exiting surface sheet 16. It should be noted that in the present embodiment, a black color is applied to the surfaces of the light-exiting surface sheets 16 to increase the light-shielding properties thereof and form the light-shielding light-exiting surface sheets 16B. As a result, in the present embodiment, the optical reflectance of the flexible substrate 30 is higher than the optical reflectance of the light-exiting surface sheets 16. Moreover, a frame-shaped panel adhesive tape 14 that adheres to both the light-exiting surface sheets 16 and the liquid crystal panel 11 is arranged therebetween. This panel adhesive tape 14 fixes the light-exiting surface sheets 16 and the liquid crystal panel 11 to one another.

The frame 22 is made from a synthetic resin. As shown in FIG. 1, the frame 22 has an elongated frame shape that is almost identical in size to the cover panel 12. The frame 22 houses the liquid crystal panel 11, the light guide plate 20, and the optical sheet 18. The frame 22 has a pair of short sides that run parallel to the X direction and that are connected to one another by a pair of long sides that run parallel to the Y direction. The frame 22 supports the cover panel 12 around the outer periphery thereof, in which the light-shielding portion 12a is formed. The frame 22 also faces the rear side substrate of the liquid crystal panel 11, which is supported from the rear side by the frame 22 around the entire periphery thereof. As shown in FIGS. 2, 4, and 5, the cross section of frame 22 is substantially stair-shaped and has 3 levels. A portion of the lowest first level portion 22a supports one of the long edges of the flexible substrate 30. The second lowest second level portion 22b supports each of the light-exiting surface sheets 16 and the outer periphery of the rear side of the liquid crystal panel 11, with the light-exiting surface sheets 16 sandwiched between the second level portion 22b and the liquid crystal panel 11. The highest third level portion 22c supports the outer periphery of the rear side of the cover panel 12. Meanwhile, a slight recess is formed in the rear side of the frame 22 to provide the stepped portion 22d. This stepped portion 22d helps to maintain a small gap between the frame 22 and the casing 34. As shown in FIGS. 4 and 5, this small gap houses the outer periphery of the reflective sheet 26.

Next, the configuration and effects of the substrate recesses 30S and the substrate protrusions 30TW that are formed in the flexible substrate 30 will be described. As shown in FIG. 3, the abovementioned substrate recesses 30S and substrate protrusions 30TW are arranged alternately, in the direction parallel to the long sides of the flexible substrate 30 (that is, parallel to the light-receiving face 20a), along the light-receiving face 20a side of the flexible substrate 30 (that is, along the overlapping portion 31). When viewed in a plan view, both the substrate recesses 30S and the substrate protrusions 30TW are rectangular in shape. Moreover, as shown in FIG. 3, each of the substrate recesses 30S faces one of the plurality of LEDs 28, and each of the substrate protrusions 30TW faces one of the spaces between adjacent LEDs 28. As a result, along the light-receiving face 20a side of the light guide plate 20, the space between the flexible substrate 30 and the edge 18e of the optical sheet 18 is larger for the portions that face the LEDs 28 than for the portions that face the spaces between adjacent LEDs 28.

Therefore, light emitted from the light-emitting surface 28a of each of the LEDs 28 proceeds not only in the direction orthogonal to the light-emitting surface 28a (that is, in the Y direction) but also in an angled (slanted) direction relative to the light-emitting surface 28a. As a result, light emitted from the LEDs 28 enters not only the portions of the light-receiving face 20a of the light guide plate 20 that face the LEDs 28 but also the portions that face the spaces between adjacent LEDs 28. The LEDs 28 are mounted on the flexible substrate 30, which contacts the light-exiting surface 20b of the light guide plate 20. Therefore, the majority of the light emitted from the light-emitting surface 28a of each of the LEDs 28 enters the light-receiving face 20a of the light guide plate 20 and proceeds towards the light-exiting surface 20b of the light guide plate 20. As shown by the dotted line in FIG. 4, in the portions of the light-receiving face 20a of the light guide plate 20 that face the LEDs 28, the light that enters the light-receiving face 20a of the light guide plate 20 and proceeds towards the light-exiting surface 20b arrives at the space between the overlapping portion 31 of the flexible substrate 30 and the edge 18e of the optical sheet 18. In other words, the light arrives at positions that overlap, when viewed in a plan view, with the interior regions of the substrate recesses 30S (an example of first light-incident portions or light-shielding portions). As shown by the dotted line in FIG. 4, the light that arrives at the positions that overlap with the interior regions of the substrate recesses 30S passes through the space between the overlapping portion 31 of the flexible substrate 30 and the edge 18e of the optical sheet 18 and arrives at the light-exiting surface sheets 16. In the present embodiment, this light is blocked by the light-shielding light-exiting surface sheets 16B.

Meanwhile, as shown by the dotted line in FIG. 5, in the portions of the light-receiving face 20a of the light guide plate 20 that face the spaces between adjacent LEDs 28, the light that enters the light-receiving face 20a of the light guide plate 20 and proceeds towards the light-exiting surface 20b arrives at the LED 28-side (that is, the light-exiting surface 20b-side) surfaces of the substrate protrusions 30TW (an example of second light-incident portions or light-reflecting portions). As shown by the dotted line in FIG. 5, the light that arrives at the substrate protrusions 30TW is reflected thereby because in the present embodiment, a reflective flexible substrate 30W is used for the flexible substrate 30. This reflected light then proceeds to return back into the light guide plate 20. In other words, of the light that enters the light-receiving face 20a of the light guide plate 20 and proceeds towards the light-exiting surface 20b, the light that enters the portions of the light-receiving face 20a that face the LEDs 28 is blocked by the light-exiting surface sheets 16, and the light that enters the portions of the light-receiving face 20a that face the spaces between adjacent LEDs 28 is reflected back into the light guide plate 20 by the substrate protrusions 30TW. As a result, along the light-receiving face 20a side of the light guide plate 20, the brightness of the portions that face the LEDs 28 is reduced, and the brightness of the portions that face the spaces between adjacent LEDs 28 is increased.

However, along the light-receiving face 20a side of the light guide plate 20, the distance between the LEDs 28 and the light-receiving face 20a is smaller for the portions that face the LEDs 28 than for the portions that face the spaces between adjacent LEDs 28. Therefore, more light enters the portions of the light-receiving face 20a that face the LEDs 28 than the portions that face the spaces between adjacent LEDs 28. Moreover, if the substrate recesses 30S and the substrate protrusions 30TW described in the present embodiment were not formed in the overlapping portion 31 of the flexible substrate 30, all of the light that entered the light-receiving face 20a of the light guide plate 20 and proceeded towards the light-exiting surface 20b would proceed towards the overlapping portion 31 of the flexible substrate 30, and all of this light would be reflected back into the light guide plate 20 by the reflective flexible substrate 30W. As a result, in this configuration in which the substrate recesses 30S and the substrate protrusions 30TW are not formed in the overlapping portion 31 of the flexible substrate 30, when viewing the light-receiving face 20a side of the light-exiting surface 20b of the light guide plate 20 from plan view, the portions that face the LEDs 28 would appear brighter than the portions that face the spaces between adjacent LEDs 28. Similarly, the portions that face the spaces between adjacent LEDs 28 would appear darker than the portions that face the LEDs 28. This would result in irregular brightness when viewing the light-receiving face 20a side of the light-exiting surface 20b of the light guide plate 20 from plan view, with an alternating pattern of bright portions and dark portions along that edge.

In contrast, in the backlight device 24 of the present embodiment, the substrate recesses 30S and the substrate protrusions 30TW are formed with the abovementioned configuration and arrangement in the overlapping portion 31 of the flexible substrate 30. Therefore, along the light-receiving face 20a side of the light guide plate 20, the brightness of the portions that face the LEDs 28 is reduced, and the brightness of the portions that face the spaces between adjacent LEDs 28 is increased. As a result, along the light-receiving face 20a side of the light guide plate 20, the brightness of the portions that face the LEDs 28 and would normally be bright is reduced, and the brightness of the portions that face the spaces between adjacent LEDs 28 and would normally be dark is increased. This results in a smaller difference in brightness between the portions that face the LEDs 28 and the portions that face the spaces between adjacent LEDs 28 along the light-receiving face 20a side of the light guide plate 20. Therefore, the brightness along the light-receiving face 20a side of the light guide plate 20 is approximately uniform. As a result, irregularities in brightness that might normally occur along the light-receiving face 20a side of the light guide plate 20 can be reduced or prevented. In the backlight device 24 of the present embodiment, the substrate recesses 30S and the substrate protrusions 30TW are formed with the abovementioned configuration and arrangement on one edge of the flexible substrate 30. Therefore, irregularities in brightness along the light-receiving face 20a side of the light-exiting surface 20b of the light guide plate 20 can be easily reduced or prevented.

In the backlight device 24 of the present embodiment, a treatment is applied that causes the positions that overlap the interior regions of the substrate recesses 30S in a plan view to exhibit a different optical reflectance than the surfaces that face the LED 28-side of the substrate protrusions 30TW. This facilitates making the optical reflectance of the portions that face the spaces between adjacent LEDs 28 (the substrate protrusions 30TW, the second light-incident portions) higher than the optical reflectance of the portions that face the LEDs 28 (the portions that overlap the interior regions of the substrate recesses 30S, the first light-incident portions) along the light-receiving face 20a side of the light-exiting surface 20b of the light guide plate 20. Furthermore, when light emitted from the LEDs 28 reaches the first light-incident portions and the second light-incident portions, the second light-incident portions reflect more of the light than do the first light-incident portions because the second light-incident portions have a higher optical reflectance than the first light-incident portions. In this case, when viewing the light-receiving face 20a side of the light-exiting surface 20b of the light guide plate 20, the portions that overlap with the second light-incident portions in a plan view will appear brighter than the portions that overlap the first light-incident portions in a plan view because the second light-incident portions reflect more light. Meanwhile, the portions that overlap with the first light-incident portions in a plan view will appear darker than the portions that overlap the second light-incident portions in a plan view because the first light-incident portions reflect less light (that is, the first light-incident portions block more light). In other words, along the light-receiving face 20a side of the light-exiting surface 20b of the light guide plate 20, the portions that face the spaces between adjacent LEDs 28 are illuminated brightly, and the portions that face the light-emitting surfaces 28a of the LEDs 28 are illuminated less brightly. This results in a smaller difference in brightness between the portions that face the light-emitting surfaces 28a of the LEDs 28 and the portions that face the spaces between adjacent LEDs 28 along the light-receiving face 20a side of the light-exiting surface 20b of the light guide plate 20. Therefore, the brightness along the light-receiving face 20a side of the light-exiting surface 20b of the light guide plate 20 can be made approximately uniform simply by changing the shape of the edge of the flexible substrate 30. As described above, the side-illumination type LED 28-equipped backlight device 24 of the present embodiment makes it possible to easily reduce or prevent irregularities in brightness along the light-receiving face 20a side of the light-exiting surface 20b of the light guide plate 20.

### Modification Example 1 of Embodiment 1

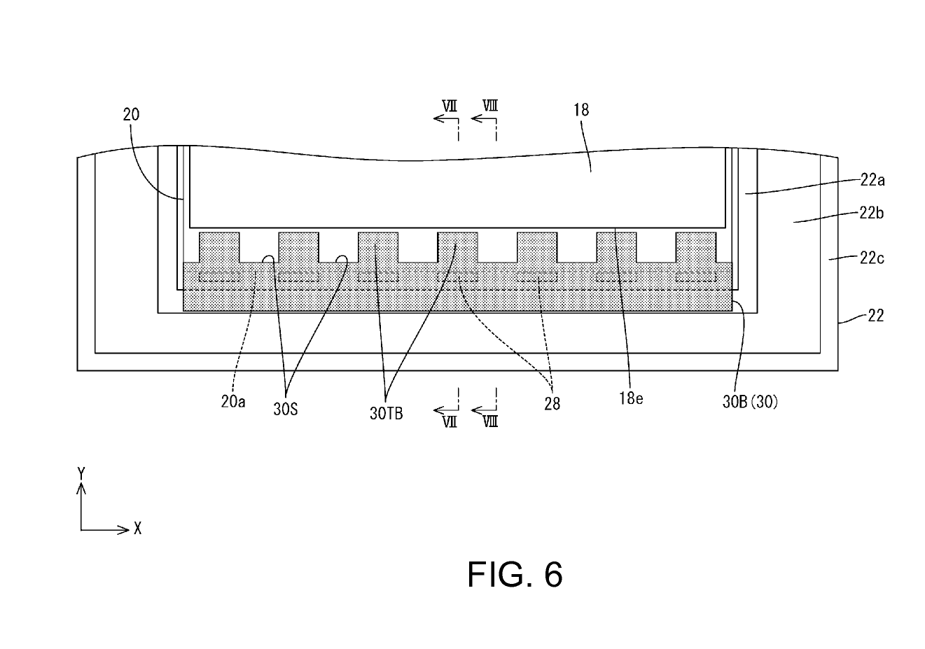

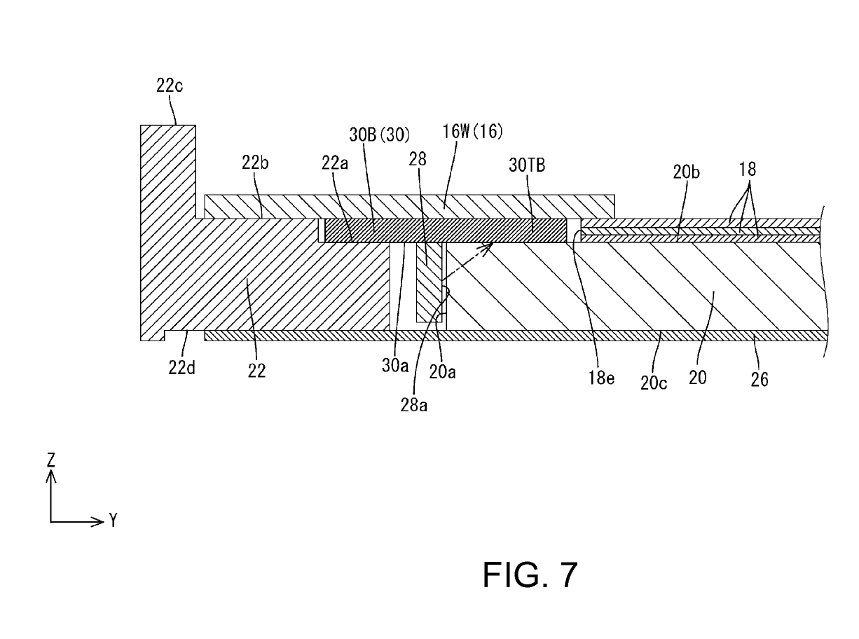

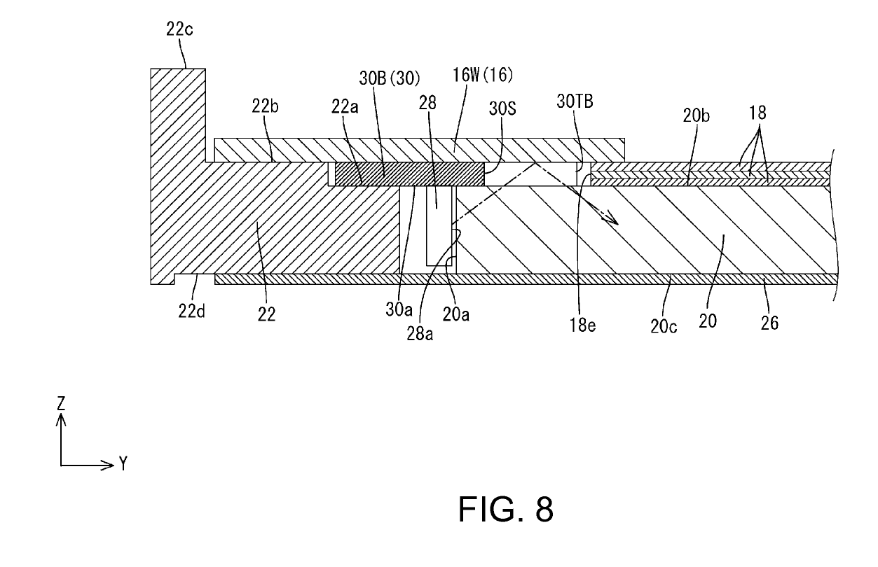

Next, Modification Example 1 of Embodiment 1 will be described. In the backlight device 24 according to Modification Example 1, the arrangement of the substrate recesses 30S and substrate protrusions 30TB that are formed in the flexible substrate 30 as well as the optical reflectance of the flexible substrate 30 and the light-exiting surface sheets 16 are different than in Embodiment 1. The other components of the present modification example are configured the same as in Embodiment 1, and descriptions of the structures, functions, and effects of those components are omitted here. As shown in FIG. 6, in Modification Example 1 of Embodiment 1, each of the substrate protrusions 30TB faces one of the plurality of LEDs 28, and each of the substrate recesses 30S faces one of the spaces between adjacent LEDs 28. In other words, the substrate recesses 30S and the substrate protrusions 30TB are arranged oppositely in terms of their positions relative to the LEDs 28 than in Embodiment 1. Moreover, as shown in FIG. 6, in the present modification example a black color is applied to the surfaces of the flexible substrate 30 to increase the light-shielding properties thereof and form the light-shielding flexible substrate 30B. As shown in FIGS. 7 and 8), a white color is applied to the surfaces of the light-exiting surface sheets 16 to increase the reflectivity thereof and form the reflective light-exiting surface sheets 16W. As a result, in the present modification example, the optical reflectance of the light-exiting surface sheets 16 is higher than the optical reflectance of the flexible substrate 30.

In the present modification example, the substrate recesses 30S and the substrate protrusions 30TB are arranged as described above. As a result, along the light-receiving face 20a side of the light-exiting surface 20b of the light guide plate 20, the space between the flexible substrate 30 and the edge 18e of the optical sheet 18 is smaller for the portions that face the LEDs 28 than for the portions that face the spaces between adjacent LEDs 28. Therefore, as shown by the dotted line in FIG. 7, in the portions of the light-receiving face 20a side of the light guide plate 20 that face the LEDs 28, the light that enters the light-receiving face 20a of the light guide plate 20 and proceeds towards the light-exiting surface 20b arrives at the LED 28-side (that is, the light-exiting surface 20b-side) surfaces of the substrate protrusions 30TB (an example of first light-incident portions or light-shielding portions). As shown by the dotted line in FIG. 7, the light that arrives at the substrate protrusions 30TB is blocked thereby because in the present modification example, a light-shielding flexible substrate 30W is used for the flexible substrate 30.

Meanwhile, as shown by the dotted line in FIG. 8, in the portions of the light-receiving face 20a side of the light guide plate 20 that face the spaces between adjacent LEDs 28, the light that enters the light-receiving face 20a of the light guide plate 20 and proceeds towards the light-exiting surface 20b arrives at the space between the overlapping portion 31 of the flexible substrate 30 and the edge 18e of the optical sheet 18. In other words, the light arrives at positions that overlap, when viewed in a plan view, with the interior regions of the substrate recesses 30S (an example of second light-incident portions or light-reflecting portions). As shown by the dotted line in FIG. 8, the light that arrives at the positions that overlap with the interior regions of the substrate recesses 30S passes through the space between the overlapping portion 31 of the flexible substrate 30 and the edge 18e of the optical sheet 18 and arrives at the light-exiting surface sheets 16. In the present modification example, this light is reflected back into the light guide plate 20 by the reflective light-exiting surface sheets 16W. As a result, similar to Embodiment 1, along the light-receiving face 20a side of the light guide plate 20, the brightness of the portions that face the LEDs 28 and would normally be bright is reduced, and the brightness of the portions that face the spaces between adjacent LEDs 28 and would normally be dark is increased. This results in a smaller difference in brightness between the portions that face the LEDs 28 and the portions that face the spaces between adjacent LEDs 28 along the light-receiving face 20a side of the light guide plate 20. Therefore, the brightness along the light-receiving face 20a side of the light guide plate 20 is approximately uniform, and as a result, irregularities in brightness along the light-receiving face 20a side of the light guide plate 20 can be easily reduced or prevented.

### Modification Example 2 of Embodiment 1

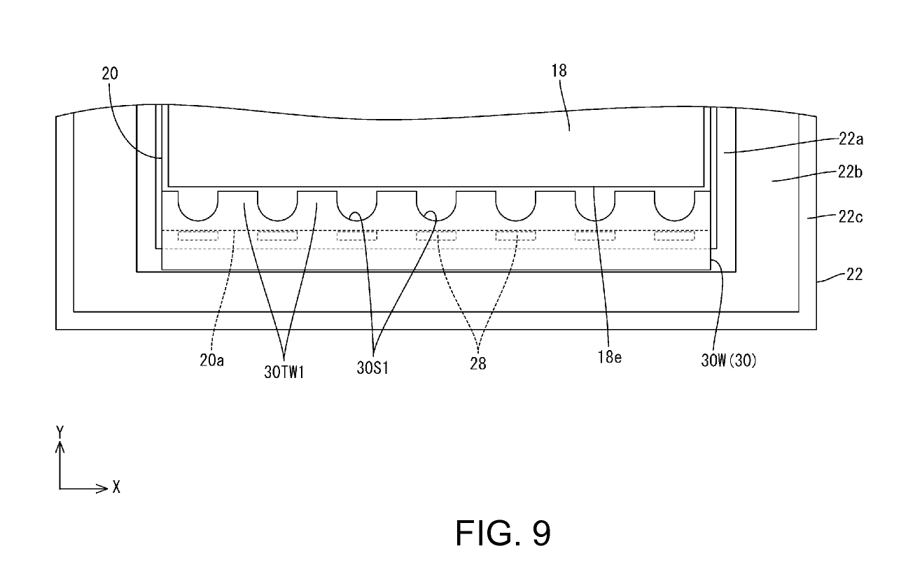

Next, Modification Example 2 of Embodiment 1 will be described. In the backlight device 24 according to Modification Example 2, the shapes of substrate recesses 30S1 and substrate protrusions 30TW1 that are formed in the flexible substrate 30 are different than in Embodiment 1. The other components of the present modification example are configured the same as in Embodiment 1, and descriptions of the structures, functions, and effects of those components are omitted here. As shown in FIG. 9, in Modification Example 2 of Embodiment 1, the ends of the substrate recesses 30S1 that are formed in the flexible substrate 30 (that is, the sides of the recesses opposite to the direction in which the recesses open) are arc-shaped when viewed in a plan view. The base sides of the substrate protrusions 30TW1 (that is, the sides opposite to the direction in which the protrusions protrude) are arc-shaped when viewed in a plan view and are formed to transition cleanly into the substrate recesses 30S1. Even when the substrate recesses 30S1 and the substrate protrusions 30TW1 are shaped as described above, the desired effect is still achieved. Of the light that enters the light-receiving face 20a of the light guide plate 20 and proceeds towards the light-exiting surface 20b, the light that enters the portions of the light-receiving face 20a that face the LEDs 28 passes through the positions that overlap with the interior regions of the substrate recesses 30S1 and is blocked by the light-exiting surface sheets 16. Meanwhile, the light that enters the portions of the light-receiving face 20a that face the spaces between adjacent LEDs 28 is reflected back into the light guide plate 20 by the substrate protrusions 30TW1. This results in a smaller difference in brightness between the portions that face the LEDs 28 and the portions that face the spaces between adjacent LEDs 28 along the light-receiving face 20a side of the light guide plate 20. Therefore, the brightness along the light-receiving face 20a side of the light guide plate 20 is approximately uniform, and as a result, irregularities in brightness along the light-receiving face 20a side of the light guide plate 20 can be easily reduced or prevented.

### Modification Example 3 of Embodiment 1

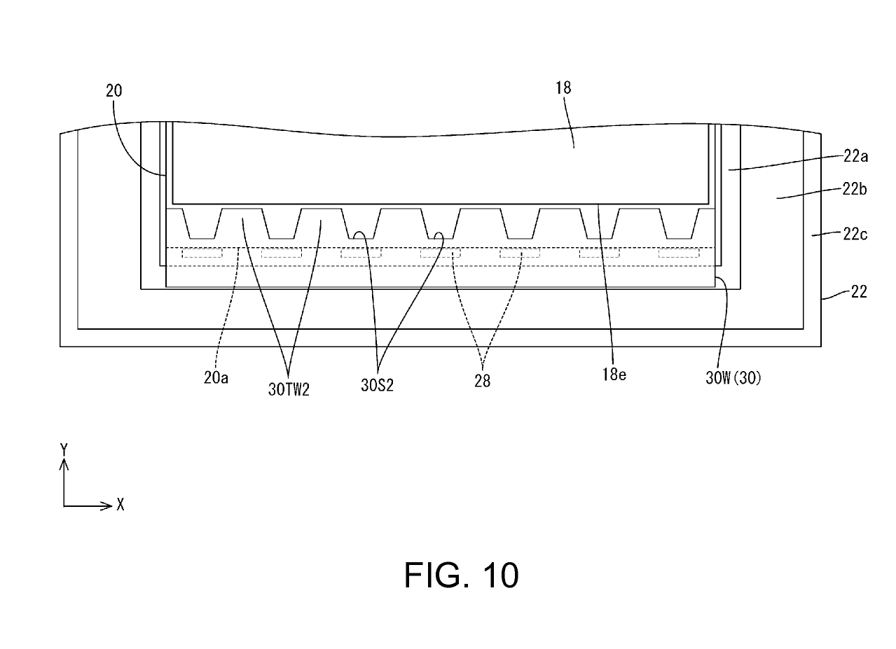

Next, Modification Example 3 of Embodiment 1 will be described. In the backlight device 24 according to Modification Example 3, the shapes of substrate recesses 30S2 and substrate protrusions 30TW2 that are formed in the flexible substrate 30 are different than in Embodiment 2. The other components of the present modification example are configured the same as in Embodiment 1, and descriptions of the structures, functions, and effects of those components are omitted here. As shown in FIG. 10, in Modification Example 3 of Embodiment 1, the ends of the substrate recesses 30S2 that are formed in the flexible substrate 30 (that is, the sides of the recesses opposite to the direction in which the recesses open) have a narrow trapezoidal shape when viewed in a plan view. The base sides of the substrate protrusions 30TW2 (that is, the sides opposite to the direction in which the protrusions protrude) have a wide trapezoidal shape when viewed in a plan view and are formed to transition cleanly into the substrate recesses 30S2. Even when the substrate recesses 30S2 and the substrate protrusions 30TW2 are shaped as described above, the desired effect is still achieved. Of the light that enters the light-receiving face 20a of the light guide plate 20 and proceeds towards the light-exiting surface 20b, the light that enters the portions of the light-receiving face 20a that face the LEDs 28 passes through the positions that overlap with the interior regions of the substrate recesses 30S2 and is blocked by the light-exiting surface sheets 16. Meanwhile, the light that enters the portions of the light-receiving face 20a that face the spaces between adjacent LEDs 28 is reflected back into the light guide plate 20 by the substrate protrusions 30TW2. This results in a smaller difference in brightness between the portions that face the LEDs 28 and the portions that face the spaces between adjacent LEDs 28 along the light-receiving face 20a side of the light guide plate 20. Therefore, the brightness along the light-receiving face 20a side of the light guide plate 20 is approximately uniform, and as a result, irregularities in brightness along the light-receiving face 20a side of the light guide plate 20 can be easily reduced or prevented.

### Modification Example 4 of Embodiment 1

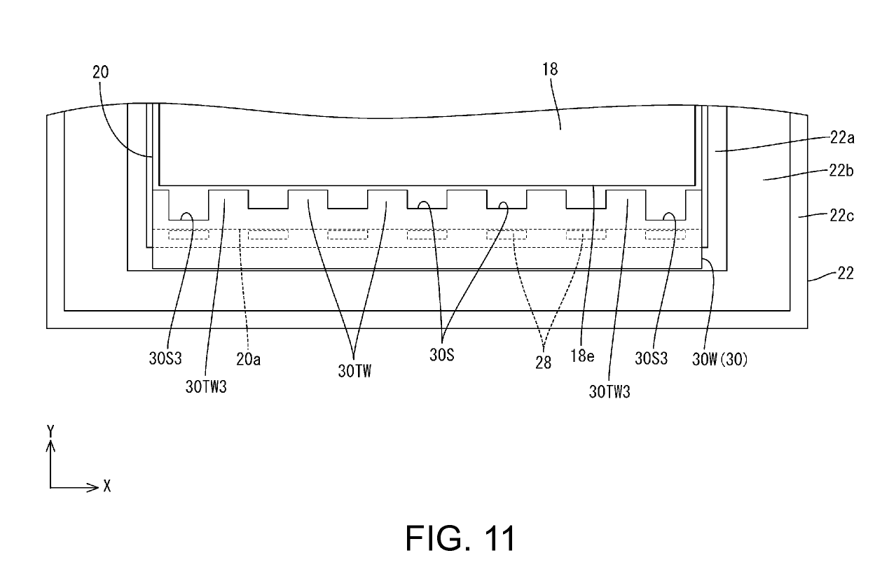

Next, Modification Example 4 of Embodiment 1 will be described. In the backlight device 24 according to Modification Example 4, the shapes of some substrate recesses 30S3 and some substrate protrusions 30TW3 that are formed in the flexible substrate 30 are different than in Embodiment 1. The other components of the present modification example are configured the same as in Embodiment 1, and descriptions of the structures, functions, and effects of those components are omitted here. As shown in FIG. 11, in Modification Example 4 of Embodiment 1, substrate recesses 30S and substrate protrusions 30TW are formed in the flexible substrate 30. On both lengthwise ends of the flexible substrate 30 (where the lengthwise direction is parallel to the line along which the LEDs 28 are mounted, the long sides of the flexible substrate 30, and the X direction), the substrate recesses 30S and the substrate protrusions 30TW are replaced by the substrate recesses 30S3 and the substrate protrusions 30TW3, which have a deeper recess depth and a longer protrusion length, respectively, than the substrate recesses 30S and the substrate protrusions 30TW formed in the other portions of the flexible substrate 30.

In this configuration of the present modification example, along the light-receiving face 20a side of the light-exiting surface 20b of the light guide plate 20, the amount of light that is blocked by the portions that overlap with the interior regions of the substrate recesses 30S3 that are provided on both lengthwise ends of the flexible substrate 30 (where the lengthwise direction is parallel to the line along which the LEDs 28 are mounted, light-receiving face 20a, and the X direction) is larger than the amount of light that is blocked by the portions that overlap with the interior regions of the substrate recesses 30S. Similarly, the amount of light that is reflected by the substrate protrusions 30TW3 that are provided on both lengthwise ends of the flexible substrate 30 is larger than the amount of light that is reflected by the substrate protrusions 30TW. As a result, if a portion of the light-exiting surface 20b is patterned to create a diffusion portion that diffuses light within the light guide plate 20, for example, the brightness along the light-receiving face 20a side of the light-exiting surface 20b of the light guide plate 20 can still be adjusted to be approximately uniform even if the pattern used on both lengthwise ends of the light-receiving face 20a side of the light-exiting surface 20b of the light guide plate 20 (where the lengthwise direction is parallel to the line along which the LEDs 28 are mounted) creates more distinctive areas of brightness and darkness than the pattern used in other portions along that edge. Moreover, irregularities in brightness along that light-receiving face 20a side of the light-exiting surface 20b of the light guide plate 20 can still be reduced or prevented.

### Embodiment 2

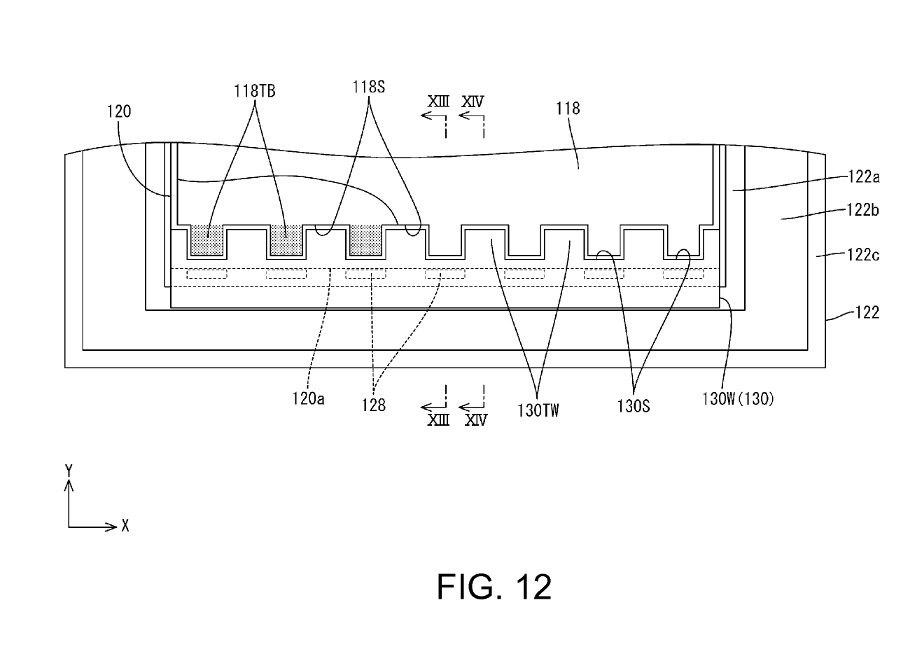

Embodiment 2 will be described below with reference to figures. In Embodiment 2, a portion of an optical sheet 118 is configured differently than the optical sheet 18 used in Embodiment 1. The other components of the present embodiment are configured the same as in Embodiment 1, and descriptions of the structures, functions, and effects of those components are omitted here. It should be noted that in FIGS. 12, 13, and 14, the components that have a reference character that is exactly 100 more than the reference character of a component in FIGS. 3, 4, and 5 correspond to the same components used in Embodiment 1.

As shown in FIG. 12, in a backlight device according to Embodiment 2, optical sheet recesses 118S that open towards a flexible substrate 130 and optical sheet protrusions 118TB that protrude towards the flexible substrate 130 are formed in the light-receiving face 20a side of the optical sheet 118. The optical sheet recesses 118S and the optical sheet protrusions 118TB are arranged alternately in the direction parallel to the long sides of the flexible substrate 130 (that is, the direction parallel to the light-receiving face 20a). Like the substrate recesses 130S and the substrate protrusions 130TW, both the optical sheet recesses 118S and the optical sheet protrusions 118TB are rectangular in shape when viewed in a plan view. Moreover, as shown in FIG. 12, the flexible substrate 130 and the optical sheet 118 are arranged such that the optical sheet protrusions 118TB fit into the substrate recesses 130S and such that the substrate protrusions 130TW fit into the optical sheet recesses 118S. Moreover, the optical sheet recesses 118S and the optical sheet protrusions 118TB are formed with the same arrangement, shape, and size in each of the plurality of sheet-shaped members included in the overall optical sheet 118.

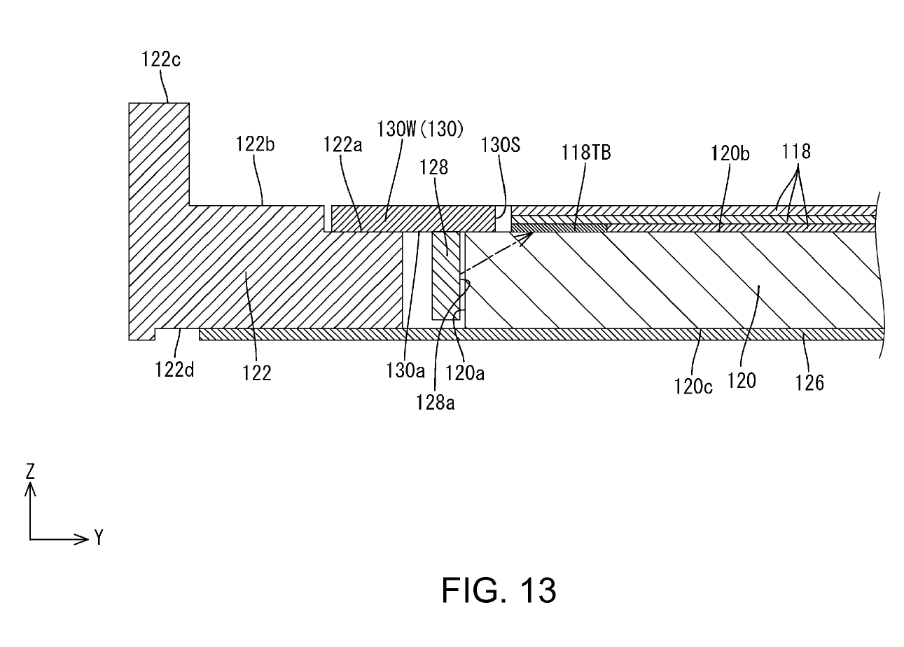

As shown in FIGS. 12 and 13, a black color is applied to the surfaces of the optical sheet protrusions 118TB of the sheet-shaped member of the optical sheet 118 closest to the light-exiting surface 120b of the light guide plate 120 (the “lower optical sheet member”) to increase the light-shielding properties thereof. A printing method such as screen printing or inkjet printing, for example, can be used to apply the black color to this portion of the optical sheet 18. Meanwhile, like in Embodiment 1, a white color is applied to the flexible substrate 130 to form the reflective flexible substrate 130W. As a result, the optical reflectance of the flexible substrate 130 is higher than the optical reflectance of the optical sheet protrusions 118TB. In the configuration of the present embodiment, in the portions of the light-receiving face 120a side of the light-exiting surface 120b of the light guide plate 120 that face the LEDs 128, the optical sheet protrusions 118TB are positioned in the interior regions of the substrate recesses 130S. In the portions that face the spaces between adjacent LEDs 128, the substrate protrusions 130TW are positioned in the interior regions of the optical sheet recesses 118S. As a result, as shown by the dotted line in FIG. 13, in the portions of the light-receiving face 120a side of the light guide plate 120 that face the LEDs 128, the light that enters the light-receiving face 120a of the light guide plate 120 and proceeds towards the light-exiting surface 120b arrives at the positions that overlap with the interior regions of the substrate recesses 130S when viewed in a plan view. That is, the light arrives at the optical sheet protrusions 118TB (an example of first light-incident portions or light-shielding portions) of the lower optical sheet member of the optical sheet 118. As described above, the optical sheet protrusions 118TB of the lower optical sheet member exhibit excellent light-shielding properties. Therefore, as shown by the dotted line in FIG. 13, the light that arrives at the optical sheet protrusions 118TB is blocked thereby.

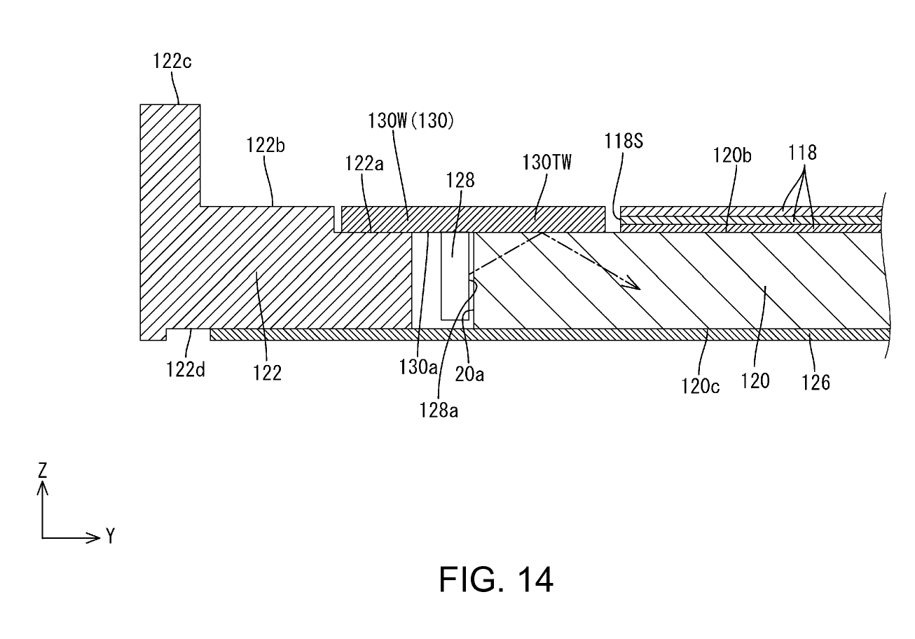

Meanwhile, as shown by the dotted line in FIG. 14, in the portions of the light-receiving face 120a side of the light guide plate 120 that face the spaces between adjacent LEDs 128, the light that enters the light-receiving face 120a of the light guide plate 120 and proceeds towards the light-exiting surface 120b arrives at the LED 128-side surface (that is, the light-exiting surface 120b-side surface) of the substrate protrusions 130TW (an example of second light-incident portions or light-reflecting portions). As shown by the dotted line in FIG. 14, the light that arrives at the substrate protrusions 130TW is reflected thereby because in the present embodiment, a reflective flexible substrate 130W is used for the flexible substrate 130. This reflected light then proceeds to return back into the light guide plate 120. In other words, of the light that enters the light-receiving face 120a of the light guide plate 120 and proceeds towards the light-exiting surface 120b, the light that enters the portions of the light-receiving face 120a that face the LEDs 128 is blocked by the optical sheet protrusions 118TB, and the light that enters the portions of the light-receiving face 120a that face the spaces between adjacent LEDs 128 is reflected back into the light guide plate 120 by the substrate protrusions 130TW. As a result, similar to Embodiment 1, along the light-receiving face 120a side of the light guide plate 120, the brightness of the portions that face the LEDs 128 and would normally be bright is reduced, and the brightness of the portions that face the spaces between adjacent LEDs 128 and would normally be dark is increased. This results in a smaller difference in brightness between the portions that face the LEDs 128 and the portions that face the spaces between adjacent LEDs 128 along the light-receiving face 120a side of the light guide plate 120. Therefore, the brightness along the light-receiving face 120a side of the light guide plate 120 is approximately uniform, and as a result, irregularities in brightness along the light-receiving face 120a side of the light guide plate 120 can be easily reduced or prevented.

### Modification Example of Embodiment 2

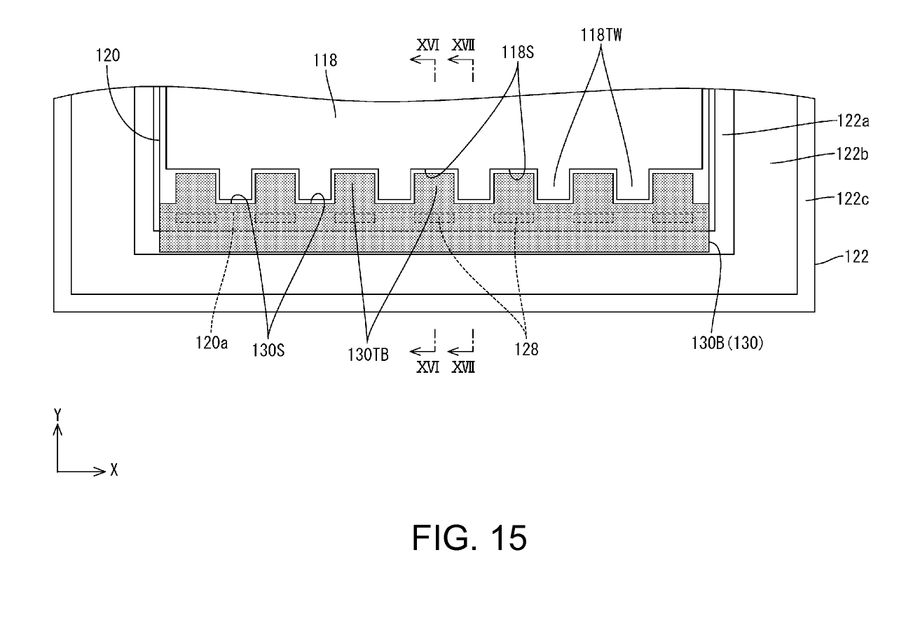

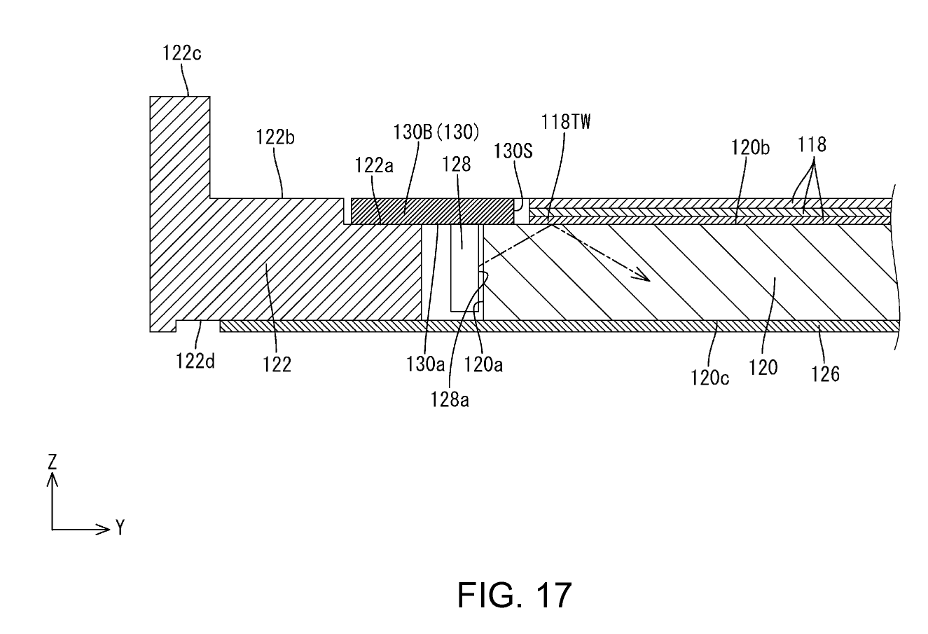

Next, a modification example of Embodiment 2 will be described. In a backlight device 124 according to the present modification example, the arrangement of substrate recesses 130S and substrate protrusions 130TB that are formed in a flexible substrate 130, the arrangement of optical sheet recesses 118S and optical sheet protrusions 118TW that are formed in an optical sheet 118, and the optical reflectance of the flexible substrate 130 and the optical sheet 118 are different than in Embodiment 2. The other components of the present modification example are configured the same as in Embodiment 2, and descriptions of the structures, functions, and effects of those components are omitted here. As shown in FIG. 15, in the present modification example of Embodiment 2, each of the substrate protrusions 130TB faces one of the plurality of LEDs 128, and each of the substrate recesses 130S faces one of the spaces between adjacent LEDs 128. Moreover, the optical sheet recesses 118S and the optical sheet protrusions 118TW of the optical sheet 118 are arranged such that the substrate protrusions 130TB fit into the optical sheet recesses 118S and such that the optical sheet protrusions 118TW fit into the substrate recesses 130S. In other words, the substrate recesses 130S and the substrate protrusions 130TB as well as the optical sheet recesses 118S and the optical sheet protrusions 118TW are arranged oppositely in terms of their positions relative to the LEDs 128 than in Embodiment 2. Furthermore, as shown in FIGS. 15 and 17, in the present modification example a printing process is used to apply a white color to the surfaces of the optical sheet protrusions 118TW of the lower optical sheet member of the optical sheet 118 in order to increase the reflectivity of those optical sheet protrusions 118TW. Meanwhile, as shown in FIG. 15, a black color is applied to the surfaces of the flexible substrate 130 to increase the light-shielding properties thereof and form the light-shielding flexible substrate 130B. As a result, the optical reflectance of the optical sheet protrusions 118TW is higher than the optical reflectance of the flexible substrate 130B.

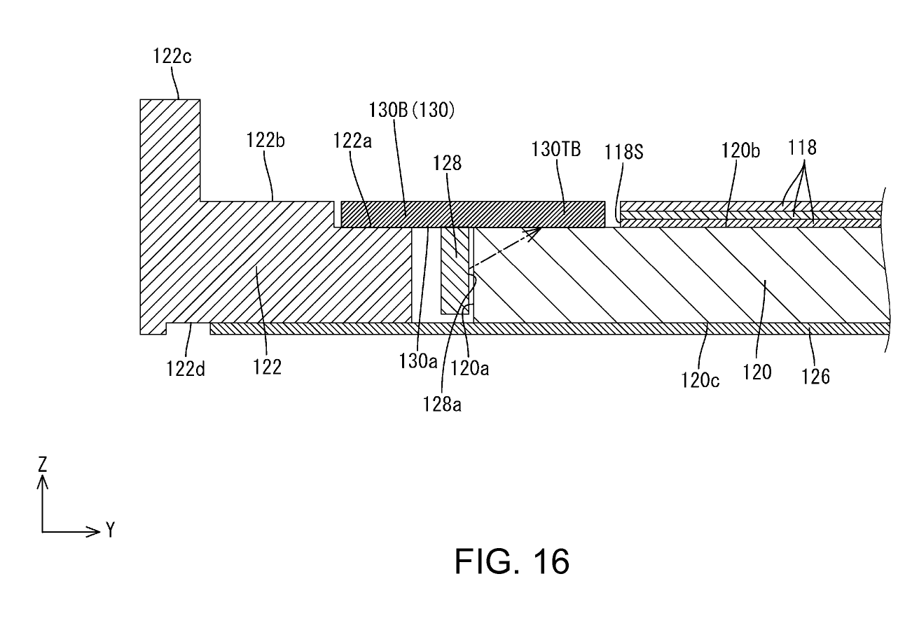

In the present modification example, the substrate recesses 130S and the substrate protrusions 130TB are arranged as described above. As a result, in the portions of the light-receiving face 120a side of the light-exiting surface 120b of the light guide plate 120 that face the LEDs 128, the substrate protrusions 130TB are positioned in the interior regions of the optical sheet recesses 118S. In the portions that face the spaces between adjacent LEDs 128, the optical sheet protrusions 118TB are positioned in the interior regions of the substrate recesses 130S. Therefore, as shown by the dotted line in FIG. 16, in the portions of the light-receiving face 120a side of the light guide plate 120 that face the LEDs 128, the light that enters the light-receiving face 120a of the light guide plate 120 and proceeds towards the light-exiting surface 120b arrives at the LED 128-side (that is, the light-exiting surface 120b-side) surfaces of the substrate protrusions 130TB (an example of first light-incident portions or light-shielding portions). As shown by the dotted line in FIG. 16, the light that arrives at the substrate protrusions 130TB is blocked thereby because in the present modification example, a light-shielding flexible substrate 130W is used for the flexible substrate 130.

Meanwhile, as shown by the dotted line in FIG. 17, in the portions of the light-receiving face 20a side of the light guide plate 120 that face the spaces between adjacent LEDs 128, the light that enters the light-receiving face 120a of the light guide plate 120 and proceeds towards the light-exiting surface 120b arrives at the positions that overlap with the interior regions of the substrate recesses 130S when viewed in a plan view. That is, the light arrives at the optical sheet protrusions 118TW (an example of second light-incident portions or light-reflecting portions) of the lower optical sheet member of the optical sheet 118. As shown by the dotted line in FIG. 17, the light that arrives at the optical sheet protrusions 118TW is reflected thereby because in the present modification example, the optical sheet protrusions 118TW exhibit excellent reflectivity. This reflected light then proceeds to return back into the light guide plate 120. As a result, similar to Embodiment 2, along the light-receiving face 120a side of the light guide plate 120, the brightness of the portions that face the LEDs 128 and would normally be bright is reduced, and the brightness of the portions that face the spaces between adjacent LEDs 128 and would normally be dark is increased. This results in a smaller difference in brightness between the portions that face the LEDs 128 and the portions that face the spaces between adjacent LEDs 128 along the light-receiving face 120a side of the light guide plate 120. Therefore, the brightness along the light-receiving face 120a side of the light guide plate 120 is approximately uniform, and as a result, irregularities in brightness along the light-receiving face 120a side of the light guide plate 120 can be easily reduced or prevented.

### Embodiment 3

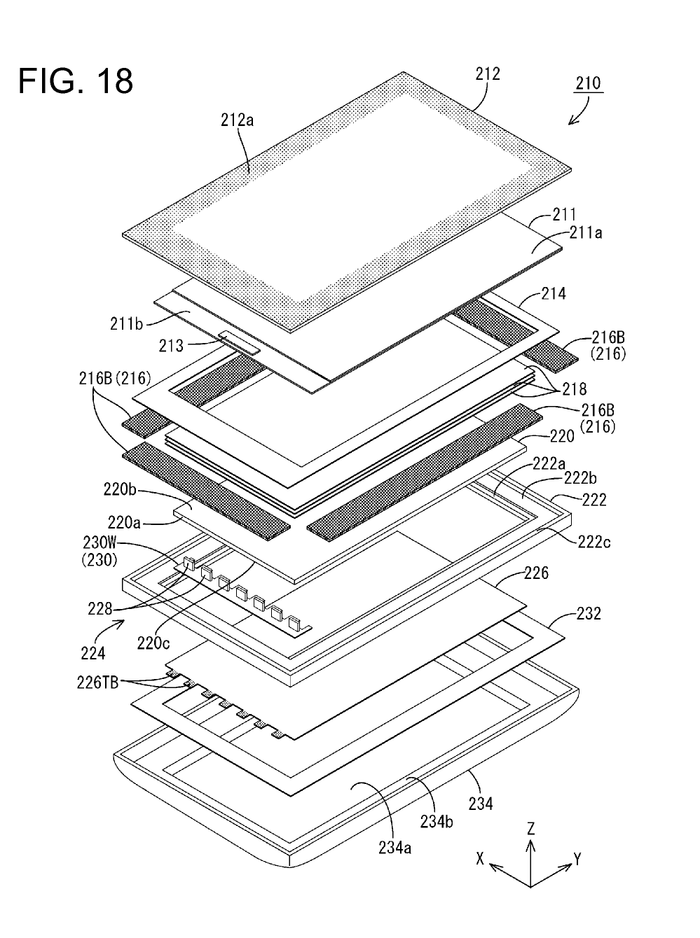

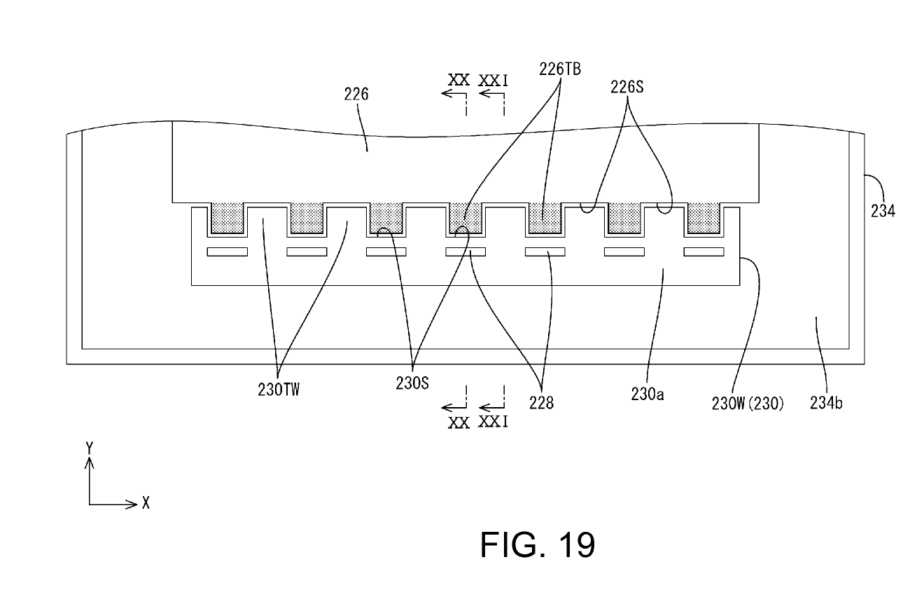

Embodiment 3 will be described below with reference to figures. In Embodiment 3, the arrangement of a flexible substrate 230 and the configuration of a portion of a reflective sheet 226 are different than in Embodiment 1. The other components of the present embodiment are configured the same as in Embodiment 1, and descriptions of the structures, functions, and effects of those components are omitted here. It should be noted that in FIGS. 18 and 19, the components that have a reference character that is exactly 200 more than the reference character of a component in FIGS. 1 and 3 correspond to the same components used in Embodiment 1.

As shown in FIGS. 18, 20, and 21, in a backlight device 224 according to Embodiment 3, the flexible substrate 230 is arranged such that the front surface thereof faces a liquid crystal panel 211 and provides a mounting surface 230a on which LEDs 228 are mounted. Moreover, the rear surface of the flexible substrate 230 faces a second level portion 234b of a casing 234. In other words, in contrast with the flexible substrates used in Embodiments 1 and 2, the flexible substrate 230 of the present embodiment is arranged such that the front surface thereof provides the mounting surface 230a on which the LEDs 228 are mounted. One of the long edges of the flexible substrate 230 contacts the light-receiving face 220a side of an opposite surface 220c of a light guide plate 220 and overlaps with that edge when viewed in a plan view. As a result, this long edge of the flexible substrate 30 faces the light-receiving face 220a side of the reflective sheet 226. The other long edge of the flexible substrate 230 is supported by the casing 234 by resting on the second level portion 234b thereof. It should be noted that in the present embodiment, a white color is applied to the surfaces of the flexible substrate 230 to increase the reflectivity thereof and form the reflective flexible substrate 230W. Moreover, the manners in which the LEDs 228 are arranged and mounted on the mounting surface 230a of the flexible substrate 230 are the same as in Embodiments 1 and 2.

Moreover, in the present embodiment the flexible substrate 230 on which the LEDs 228 are mounted is positioned on the opposite surface 220c-side of the light guide plate 220. As a result, the majority of the light emitted from the light-emitting surfaces 228a of the LEDs 228 enters the light-receiving face 220a of the light guide plate 220 and proceeds towards the opposite surface 220c of the light guide plate 220.

As shown in FIGS. 18 and 19, in the present embodiment reflective sheet recesses 226S that open towards the flexible substrate 230 and reflective sheet protrusions 226TB that protrude towards the flexible substrate 230 are formed in the light-receiving face 220a side of the reflective sheet 226. The reflective sheet recesses 226S and the reflective sheet protrusions 226TB are arranged alternately in the direction parallel to the long side of the flexible substrate 230 (that is, the direction parallel to the light-receiving face 220a) Like the substrate recesses 230S and the substrate protrusions 230TW, both the reflective sheet recesses 226S and the reflective sheet protrusions 226TB are rectangular in shape when viewed in a plan view. Moreover, as shown in FIG. 19, the flexible substrate 230 and the reflective sheet 226 are arranged such that the reflective sheet protrusions 226TB fit into the substrate recesses 230S and such that the substrate protrusions 230TW fit into the reflective sheet recesses 226S. It should be noted that because the reflective sheet recesses 226S and the reflective sheet protrusions 226TB that are formed in one of the lengthwise ends of the reflective sheet 226 fit together, respectively, with the substrate protrusions 230TW and the substrate recesses 230S formed in the flexible substrate 230, the reflective sheet 226 is shorter in length (that is, the dimension in the X direction) than the reflective sheets used in Embodiments 1 and 2.

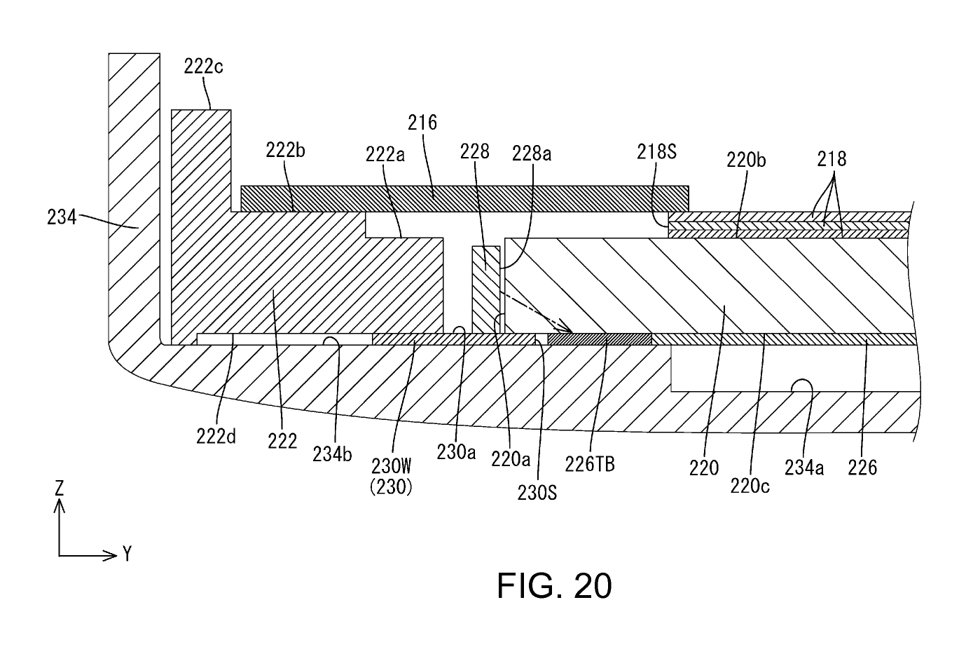

Here, a printing process is used to apply a black color to the surfaces of the reflective sheet protrusions 226TB of the reflective sheet 226 in order to increase the light-shielding properties of those reflective sheet protrusions 226TB. As a result, the optical reflectance of the flexible substrate 230 is higher than the optical reflectance of the optical sheet protrusions 226TB. In the configuration of the present embodiment, in the portions of the light-receiving face 220a side of the opposite surface 220c of the light guide plate 220 that face the LEDs 228, the reflective sheet protrusions 226TB are positioned in the interior regions of the substrate recesses 230S. In the portions that face the spaces between adjacent LEDs 228, the substrate protrusions 230TW are positioned in the interior regions of the reflective sheet recesses 226S. As a result, as shown by the dotted line in FIG. 20, in the portions of the light-receiving face 220a side of the light guide plate 220 that face the LEDs 228, the light that enters the light-receiving face 220a of the light guide plate 220 and proceeds towards the opposite surface 220c arrives at the positions that overlap with the interior regions of the substrate recesses 230S when viewed in a plan view. That is, the light arrives at the reflective sheet protrusions 226TB (an example of first light-incident portions or light-shielding portions). As described above, the reflective sheet protrusions 226TB exhibit excellent light-shielding properties. Therefore, as shown by the dotted line in FIG. 20, the light that arrives at the reflective sheet protrusions 226TB is blocked thereby.

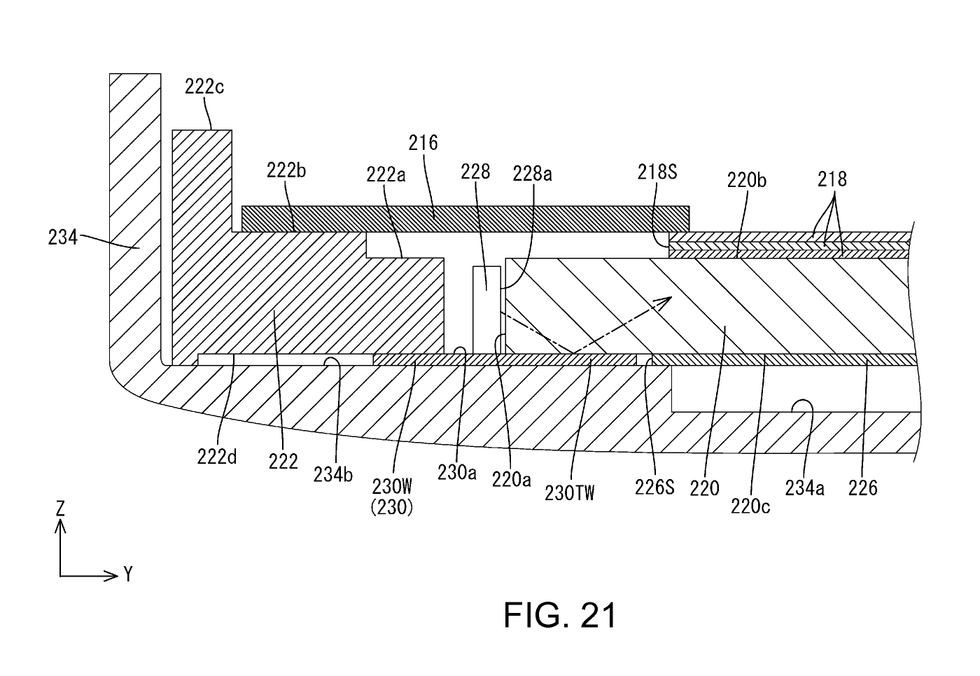

Meanwhile, as shown by the dotted line in FIG. 21, in the portions of the light-receiving face 220a side of the light guide plate 220 that face the spaces between adjacent LEDs 228, the light that enters the light-receiving face 220a of the light guide plate 220 and proceeds towards the opposite surface 220c arrives at the LED 228-side (that is, the opposite surface 220c-side) surfaces of the substrate protrusions 230TW (an example of second light-incident portions or light-reflecting portions). As shown by the dotted line in FIG. 21, the light that arrives at the substrate protrusions 230TW is reflected thereby because in the present embodiment, a reflective flexible substrate 230W is used for the flexible substrate 230. This reflected light then proceeds to return back into the light guide plate 220. In other words, of the light that enters the light-receiving face 220a of the light guide plate 220 and proceeds towards the opposite surface 220c, the light that enters the portions of the light-receiving face 220a that face the LEDs 228 is blocked by the reflective sheet protrusions 226TB, and the light that enters the portions of the light-receiving face 220a that face the spaces between adjacent LEDs 228 is reflected back into the light guide plate 220 by the substrate protrusions 230TW. As a result, similar to Embodiments 1 and 2, along the light-receiving face 220a side of the light guide plate 220, the brightness of the portions that face the LEDs 228 and would normally be bright is reduced, and the brightness of the portions that face the spaces between adjacent LEDs 228 and would normally be dark is increased. This results in a smaller difference in brightness between the portions that face the LEDs 228 and the portions that face the spaces between adjacent LEDs 228 along the light-receiving face 220a side of the light guide plate 220. Therefore, the brightness along the light-receiving face 220a side of the light guide plate 220 is approximately uniform, and as a result, irregularities in brightness along the light-receiving face 220a side of the light guide plate 220 can be easily reduced or prevented.

### Modification Example of Embodiment 3

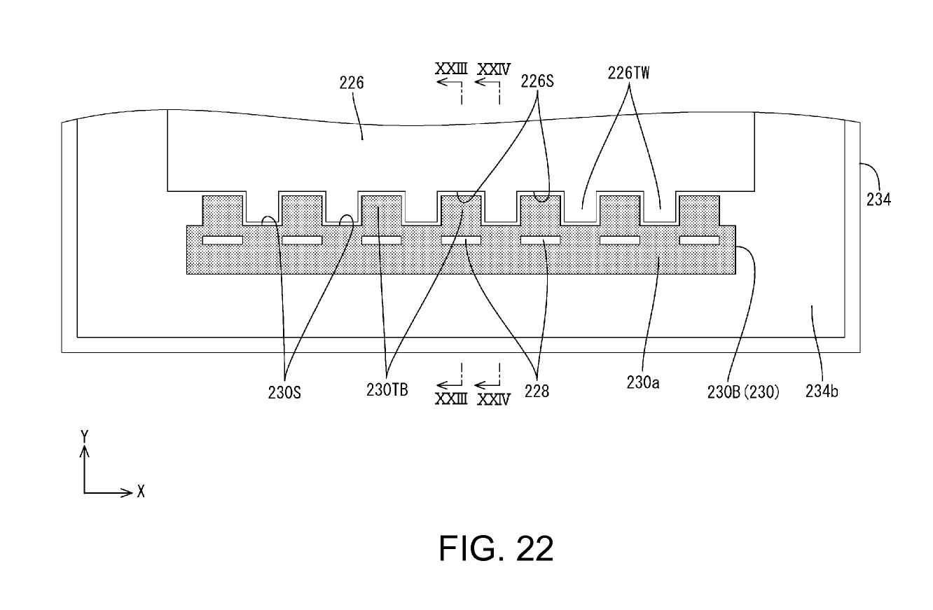

Next, a modification example of Embodiment 3 will be described. In a backlight device according to the present modification example, the arrangement of substrate recesses 130S and substrate protrusions 230TB that are formed in a flexible substrate 230, the arrangement of reflective sheet recesses 226S and reflective sheet protrusions 226TW that are formed in an optical sheet 226, and the optical reflectance of the flexible substrate 230 and the reflective sheet 226 are different than in Embodiment 3. The other components of the present modification example are configured the same as in Embodiment 3, and descriptions of the structures, functions, and effects of those components are omitted here. As shown in FIG. 22, in the present modification example of Embodiment 3, each of the substrate protrusions 230TB faces one of the plurality of LEDs 228, and each of the substrate recesses 230S faces one of the spaces between adjacent LEDs 228. Moreover, the reflective sheet recesses 226S and the reflective sheet protrusions 226TW of the optical sheet 226 are arranged such that the substrate protrusions 230TB fit into the reflective sheet recesses 226S and such that the reflective sheet protrusions 226TW fit into the substrate recesses 230S. In other words, the substrate recesses 230S and the substrate protrusions 230TB as well as the reflective sheet recesses 226S and the reflective sheet protrusions 226TW are arranged oppositely in terms of their positions relative to the LEDs 128 than in Embodiment 3. Furthermore, in the present modification example a printing process is used to apply a white color to the entire surface of the reflective sheet 226 (including the reflective sheet protrusions 226TW) in order to increase the reflectivity thereof. Meanwhile, as shown in FIG. 22, a black color is applied to the surfaces of the flexible substrate 230 to increase the light-shielding properties thereof and form the light-shielding flexible substrate 230B. As a result, the optical reflectance of the reflective sheet protrusions 226TW is higher than the optical reflectance of the flexible substrate 230B.

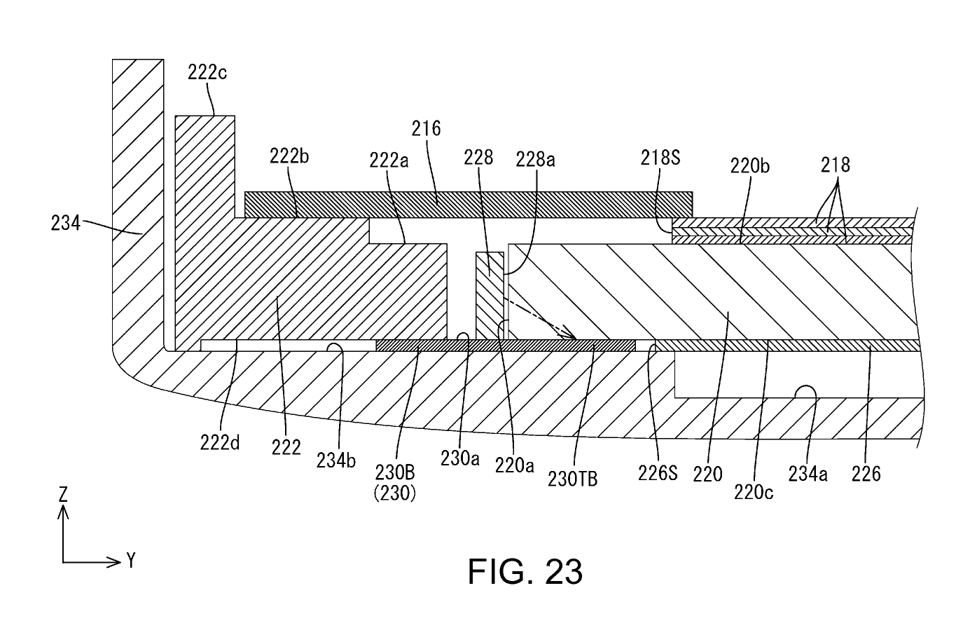

In the present modification example, the substrate recesses 230S and the substrate protrusions 230TB are arranged as described above. As a result, in the portions of the light-receiving face 220a side of the opposite surface 220c of the light guide plate 220 that face the LEDs 228, the substrate protrusions 230TB are positioned in the interior regions of the reflective sheet recesses 226S. In the portions that face the spaces between adjacent LEDs 228, the reflective sheet protrusions 226TB are positioned in the interior regions of the substrate recesses 230S. As a result, as shown by the dotted line in FIG. 23, in the portions of the light-receiving face 220a side of the light guide plate 220 that face the LEDs 228, the light that enters the light-receiving face 220a of the light guide plate 220 and proceeds towards the opposite surface 220c arrives at the LED 228-side (that is, the opposite surface 220c-side) surfaces of the substrate protrusions 230TB (an example of first light-incident portions or light-shielding portions). As shown by the dotted line in FIG. 23, the light that arrives at the substrate protrusions 230TB is blocked thereby because in the present modification example, a light-shielding flexible substrate 230B is used for the flexible substrate 230.

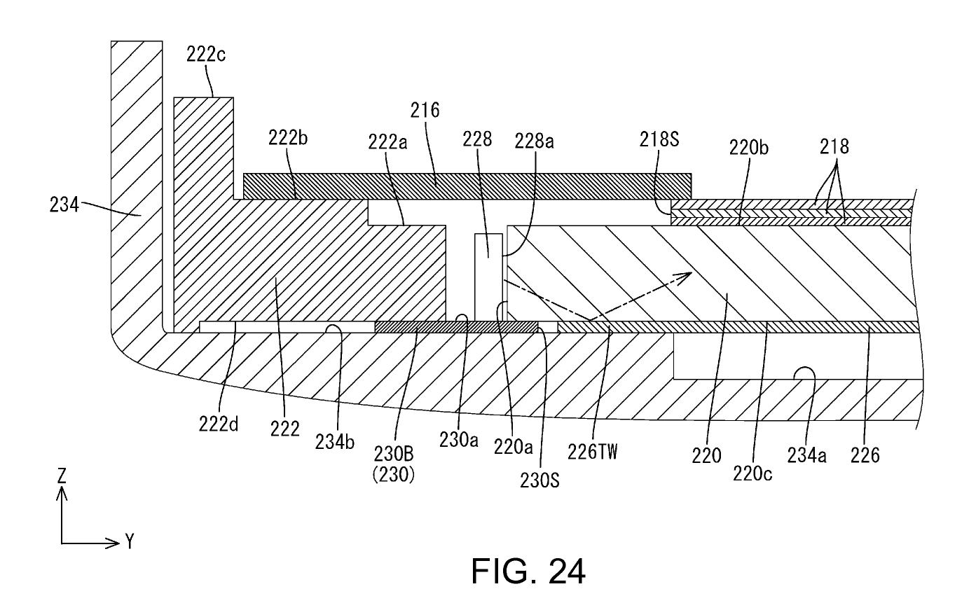

Meanwhile, as shown by the dotted line in FIG. 24, in the portions of the light-receiving face 220a side of the light guide plate 220 that face the spaces between adjacent LEDs 228, the light that enters the light-receiving face 220a of the light guide plate 220 and proceeds towards the opposite surface 220c arrives at the positions that overlap with the interior regions of the substrate recesses 230S when viewed in a plan view. That is, the light arrives at the reflective sheet protrusions 226TW (an example of second light-incident portions or light-reflecting portions). As shown by the dotted line in FIG. 24, the light that arrives at the reflective sheet protrusions 226TW is reflected thereby because in the present modification example, the reflective sheet protrusions 226TW exhibit excellent reflectivity. This reflected light then proceeds to return back into the light guide plate 220. As a result, similar to Embodiment 3, along the light-receiving face 220a side of the light guide plate 220, the brightness of the portions that face the LEDs 228 and would normally be bright is reduced, and the brightness of the portions that face the spaces between adjacent LEDs 228 and would normally be dark is increased. This results in a smaller difference in brightness between the portions that face the LEDs 228 and the portions that face the spaces between adjacent LEDs 228 along the light-receiving face 220a side of the light guide plate 220. Therefore, the brightness along the light-receiving face 220a side of the light guide plate 220 is approximately uniform, and as a result, irregularities in brightness along the light-receiving face 220a side of the light guide plate 220 can be easily reduced or prevented.

### Embodiment 4

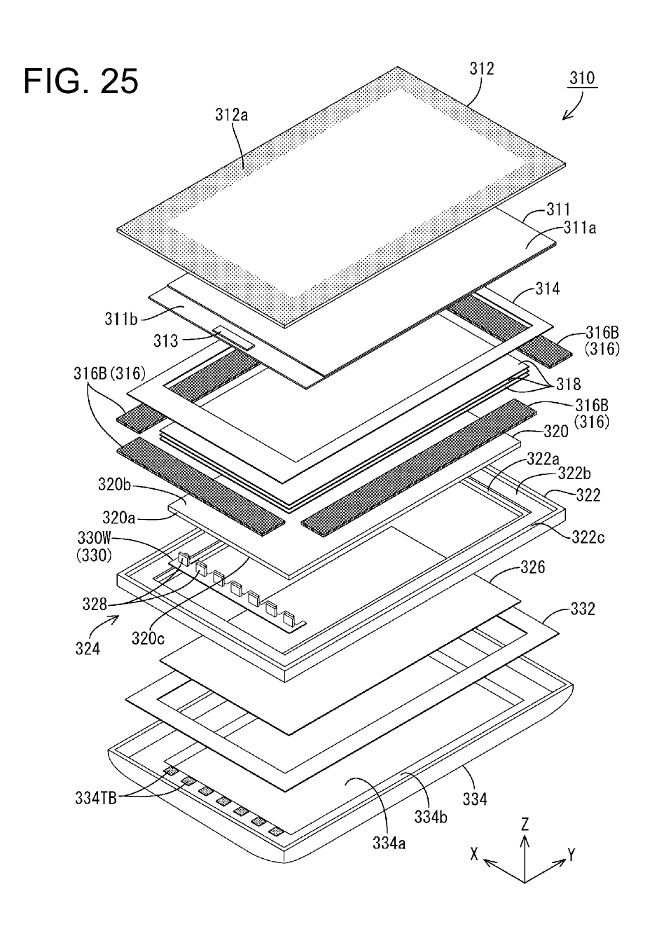

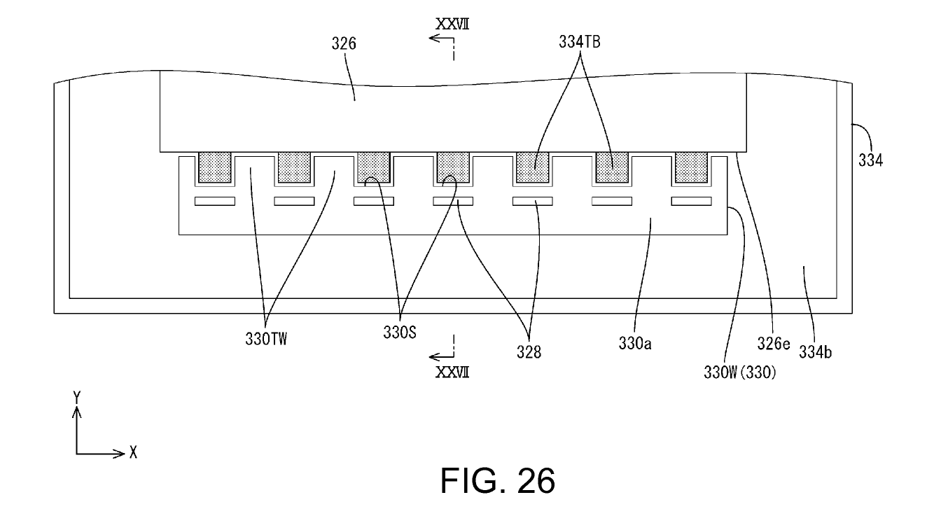

Embodiment 4 will be described below with reference to figures. In Embodiment 4, a reflective sheet 326 and a casing 334 (an example of a supporting member) are configured differently than the reflective sheet and casing used in Embodiment 3. The other components of the present embodiment are configured the same as in Embodiment 3, and descriptions of the structures, functions, and effects of those components are omitted here. It should be noted that in FIGS. 25 and 26, the components that have a reference character that is exactly 100 more than the reference character of a component in FIGS. 18 and 19 correspond to the same components used in Embodiment 3.

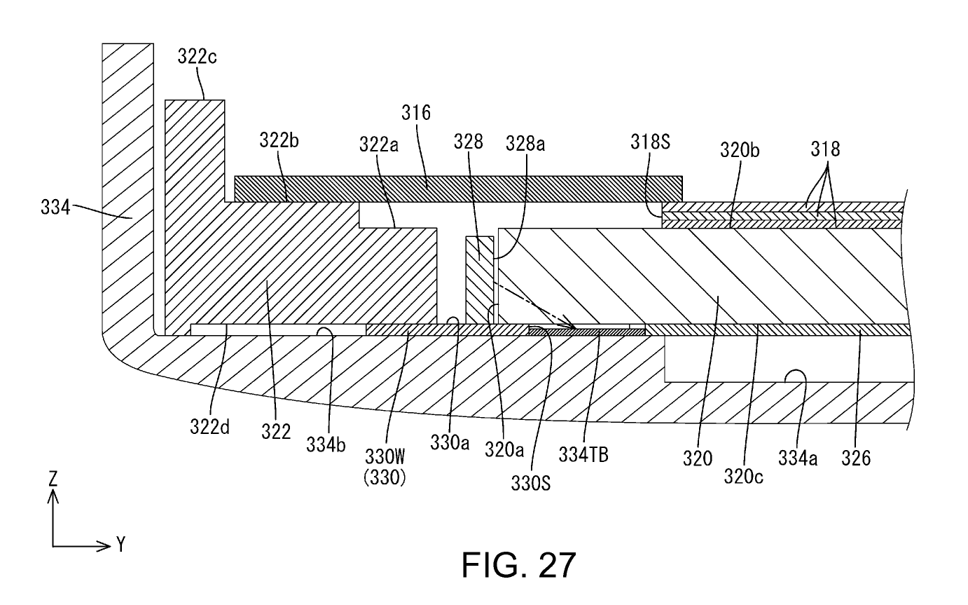

As shown in FIG. 25, in a backlight device 324 according to Embodiment 4, the reflective sheet 326 is configured the same as the reflective sheet in Embodiment 1. Meanwhile, the configuration and arrangement of a flexible substrate 330 are the same as the configuration and arrangement of the flexible substrate used in Embodiment 3. As shown in FIG. 26, in the present embodiment a printing process is used to apply a black color to sections 334TB to increase the light-shielding properties thereof. The sections 334TB are formed in the second level portion 334b (an example of a supporting surface) of the casing 334 and overlap with the interior regions of the substrate recesses 330S formed in the flexible substrate 330 when viewed in a plan view. As a result, the optical reflectance of the flexible substrate 330 is higher than the optical reflectance of the sections 334TB of the casing 334 that overlap with the interior regions of the substrate recesses 330S when viewed in a plan view. The present embodiment is configured as described above. As a result, as shown by the dotted line in FIG. 27, in the portions of the light-receiving face 320a side of the light guide plate 320 that face the LEDs 328, the light that enters the light-receiving face 320a of the light guide plate 320 and proceeds towards the opposite surface 320c passes therethrough and arrives at the positions that overlap with the interior regions of the substrate recesses 330S when viewed in a plan view. That is, the light arrives at the sections 334TB (an example of first light-incident portions or light-shielding portions) of the casing 334. As described above, the sections 334TB of the casing 334 exhibit excellent light-shielding properties. Therefore, as shown by the dotted line in FIG. 27, the light that arrives at these sections 334TB is blocked thereby.

Meanwhile, in the portions of the light-receiving face 320a side of the light guide plate 320 that face the spaces between adjacent LEDs 328, the light that enters the light-receiving face 320a of the light guide plate 320 and proceeds towards the opposite surface 320c arrives at the LED 328-side surface (that is, the opposite surface 320c-side surface) of the substrate protrusions 330TW (an example of second light-incident portions or light-reflecting portions). The light that arrives at the substrate protrusions 330TW is reflected thereby because in the present embodiment, a reflective flexible substrate 330W is used for the flexible substrate 330. This reflected light then proceeds to return back into the light guide plate 320. In other words, of the light that enters the light-receiving face 320a of the light guide plate 320 and proceeds towards the opposite surface 320c, the light that enters the portions of the light-receiving face 320a that face the LEDs 328 is blocked by the sections 334TB of the casing 334, and the light that enters the portions of the light-receiving face 320a that face the spaces between adjacent LEDs 328 is reflected back into the light guide plate 320 by the substrate protrusions 330TW. As a result, similar to Embodiment 3, along the light-receiving face 320a side of the light guide plate 320, the brightness of the portions that face the LEDs 328 and would normally be bright is reduced, and the brightness of the portions that face the spaces between adjacent LEDs 328 and would normally be dark is increased. This results in a smaller difference in brightness between the portions that face the LEDs 328 and the portions that face the spaces between adjacent LEDs 328 along the light-receiving face 320a side of the light guide plate 320. Therefore, the brightness along the light-receiving face 320a side of the light guide plate 320 is approximately uniform, and as a result, irregularities in brightness along the light-receiving face 320a side of the light guide plate 320 can be easily reduced or prevented.

### Modification Example 1 of Embodiment 4

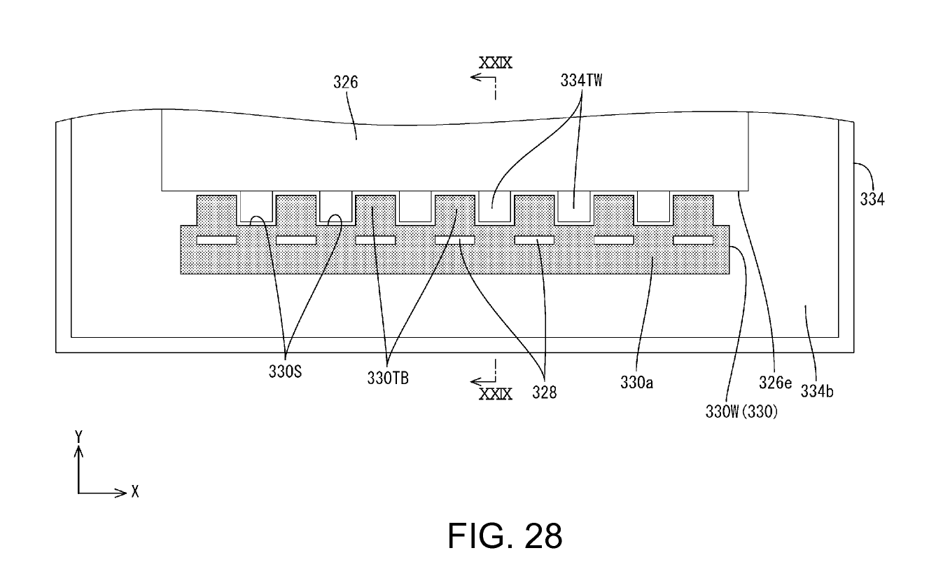

Next, Modification Example 1 of Embodiment 4 will be described. In a backlight device according to Modification Example 1, the arrangement of substrate recesses 330S and substrate protrusions 330TB that are formed in a flexible substrate 330 as well as the optical reflectance of the flexible substrate 330 and sections 334TW that are formed in a casing 334 and overlap with the interior regions of the substrate recesses 330S are different than in Embodiment 4. The other components of the present modification example are configured the same as in Embodiment 4, and descriptions of the structures, functions, and effects of those components are omitted here. As shown in FIG. 22, in Modification Example 1 of Embodiment 4, each of the substrate protrusions 330TB faces one of a plurality of LEDs 328, and each of the substrate recesses 330S faces one of the spaces between adjacent LEDs 328. In other words, the substrate recesses 330S and the substrate protrusions 330TB are arranged oppositely in terms of their positions relative to the LEDs 328 than in Embodiment 4. Moreover, as shown in FIG. 28, a printing process is used to apply a white color to the sections 334TW to increase the reflectivity thereof. The sections 334TW are formed in the second level portion 334b (an example of a supporting surface) of the casing 334 and overlap with the interior regions of the substrate recesses 330S formed in the flexible substrate 330 when viewed in a plan view. Meanwhile, as shown in FIG. 28, a black color is applied to the surfaces of the flexible substrate 330 to increase the light-shielding properties thereof and form the light-shielding flexible substrate 330B. As a result, the optical reflectance of the flexible substrate 330 is lower than the optical reflectance of the sections 334TW of the casing 334 that overlap with the interior regions of the substrate recesses 330S when viewed in a plan view.

The present modification example is configured as described above. As a result, in the portions of the light-receiving face 320a side of the light guide plate 320 that face the LEDs 328, the light that enters the light-receiving face 320a of the light guide plate 320 and proceeds towards the opposite surface 320c arrives at the LED 328-side surface (that is, the opposite surface 320c-side surface) of the substrate protrusions 330TB (an example of first light-incident portions or light-shielding portions). In the present modification example, the light that arrives at the substrate protrusions 330TB is blocked thereby because in the present modification example, a light-shielding flexible substrate 330B is used for the flexible substrate 330.

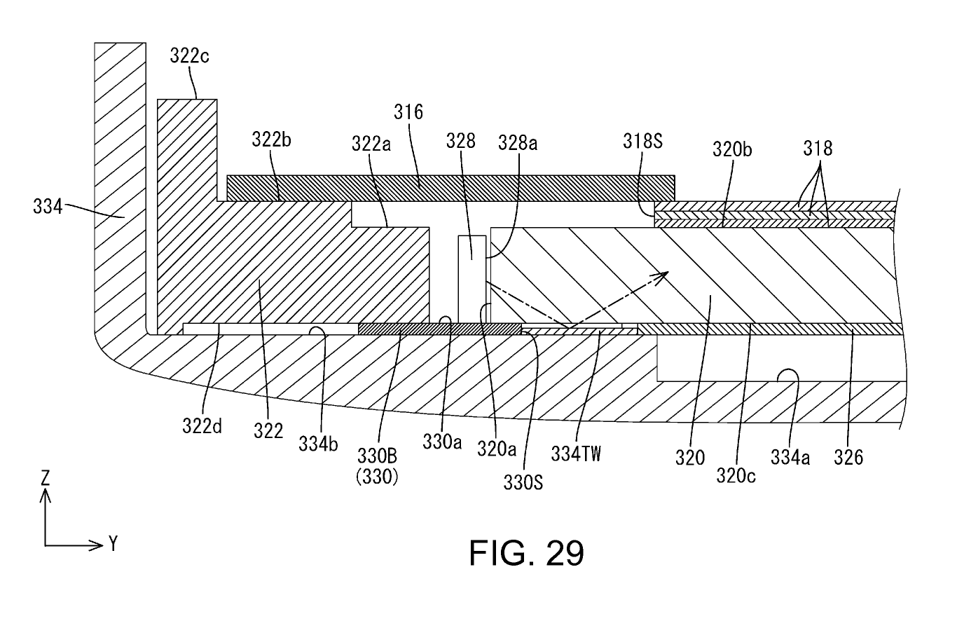

Meanwhile, as shown by the dotted line in FIG. 29, in the portions of the light-receiving face 320a side of the light guide plate 320 that face the spaces between adjacent LEDs 328, the light that enters the light-receiving face 320a of the light guide plate 320 and proceeds towards the opposite surface 320c passes therethrough and arrives at the positions that overlap with the interior regions of the substrate recesses 330S when viewed in a plan view. That is, the light arrives at the sections 334TW (an example of second light-incident portions or light-reflecting portions) of the casing 334. As shown by the dotted line in FIG. 29, the light that arrives at the sections 326TW of the casing 334 is reflected thereby because in the present modification example, the sections 334TW exhibit excellent reflectivity. This reflected light then proceeds to return back into the light guide plate 320. As a result, similar to Embodiment 4, along the light-receiving face 320a side of the light guide plate 320, the brightness of the portions that face the LEDs 328 and would normally be bright is reduced, and the brightness of the portions that face the spaces between adjacent LEDs 328 and would normally be dark is increased. This results in a smaller difference in brightness between the portions that face the LEDs 328 and the portions that face the spaces between adjacent LEDs 328 along the light-receiving face 320a side of the light guide plate 320. Therefore, the brightness along the light-receiving face 320a side of the light guide plate 320 is approximately uniform, and as a result, irregularities in brightness along the light-receiving face 320a side of the light guide plate 320 can be easily reduced or prevented.

### Modification Example 2 of Embodiment 4

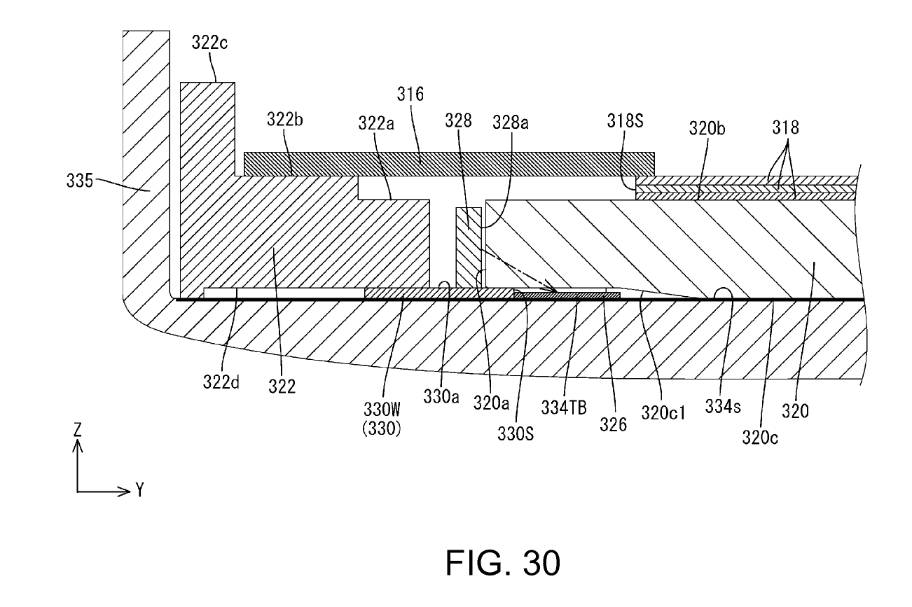

Next, Modification Example 2 of Embodiment 4 will be described. In a backlight device according to Modification Example 2, a casing 335 and a light guide plate 320 are configured differently than the casing and light guide plate used in Embodiment 4. Moreover, the backlight device according to Modification Example 2 does not include a reflective sheet. The other components of the present modification example are configured the same as in Embodiment 4, and descriptions of the structures, functions, and effects of those components are omitted here. As shown in FIG. 30, in Modification Example 2 of Embodiment 4 the casing 335 is configured differently than the casings used in Embodiments 1 to 3 in that the casing 335 does not have stair-shaped portions. The casing 335 is substantially box-shaped. As a result, the casing 335 only has one supporting surface, the bottom floor portion 334s. A white color is applied to the bottom floor portion 334s of the casing 335 to increase the reflectivity of that bottom floor portion 334s. Moreover, the backlight device of the present modification example does not include a reflective sheet. The opposite surface 320c of the light guide plate 320 contacts the bottom floor portion 334s of the casing 335 directly. Furthermore, in the present modification example a slanted surface 320c1 is formed in the opposite surface 320c of the light guide plate 320. The slanted surface 320c1 is formed along the light-receiving face 320a and slants from the rear side of the light guide plate 320 towards the front side of the light guide plate 320. Forming this slanted surface 320c1 in the light guide plate 320 creates a gap between the opposite surface 320c and a reflective sheet 326. The flexible substrate 330 is arranged such that the substrate recesses 330S and the substrate protrusions fit into this gap.

The present modification example is configured as described above. As a result, as shown by the dotted line in FIG. 30, in the portions of the light-receiving face 320a side of the light guide plate 320 that face the LEDs 328, the light that enters the light-receiving face 320a of the light guide plate 320 and proceeds towards the opposite surface 320c passes therethrough and arrives at the positions that overlap with the interior regions of the substrate recesses 330S when viewed in a plan view. That is, the light arrives at and is blocked by the sections 334TB (an example of first light-incident portions or light-shielding portions) of the casing 335. Meanwhile, in the portions of the light-receiving face 320a side of the light guide plate 320 that face the spaces between adjacent LEDs 328, the light that enters the light-receiving face 320a of the light guide plate 320 and proceeds towards the opposite surface 320c passes therethrough, arrives at the bottom floor portion 334s (an example of second light-incident portions or light-reflecting portions) of the casing 335, and is reflected back into the light guide plate 320. As a result, similar to Embodiment 4, along the light-receiving face 320a side of the light guide plate 320, the brightness of the portions that face the LEDs 328 and would normally be bright is reduced, and the brightness of the portions that face the spaces between adjacent LEDs 328 and would normally be dark is increased. This results in a smaller difference in brightness between the portions that face the LEDs 328 and the portions that face the spaces between adjacent LEDs 328 along the light-receiving face 320a side of the light guide plate 320. Therefore, the brightness along the light-receiving face 320a side of the light guide plate 320 is approximately uniform, and as a result, irregularities in brightness along the light-receiving face 320a side of the light guide plate 320 can be easily reduced or prevented.

### Modification Example 3 of Embodiment 4

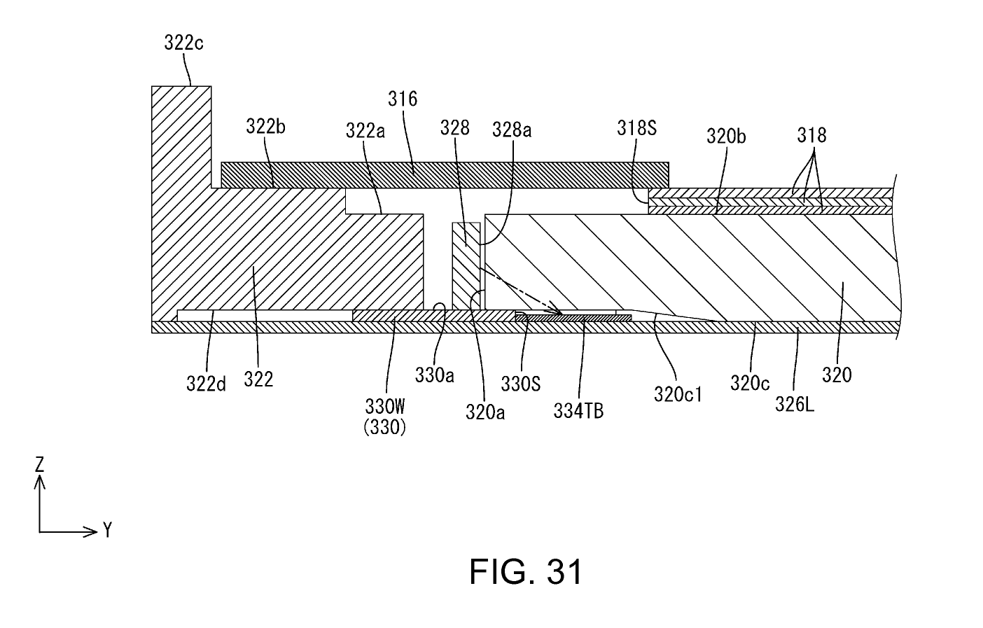

Next, Modification Example 3 of Embodiment 4 will be described. In a backlight device according to Modification Example 3, a reflective sheet 326L and a light guide plate 320 are configured differently than the reflective sheet and light guide plate used in Embodiment 4. The other components of the present modification example are configured the same as in Embodiment 4, and descriptions of the structures, functions, and effects of those components are omitted here. As shown in FIG. 31, in Modification Example 3 of Embodiment 4 the light guide plate 320 is configured the same as the light guide plate used in Modification Example 2. A slanted surface 320c1 is formed in the opposite surface 320c of the light guide plate 320. Next, the reflective sheet 326L is arranged to contact the opposite surface 320c of the light guide plate 320 and the surface of the flexible substrate 330 that is opposite to the mounting surface 330a thereof. Furthermore, the reflective sheet 326L is large enough to extend all the way to the outer face of a frame 322.

The present modification example is configured as described above. As a result, as shown by the dotted line in FIG. 31, in the portions of the light-receiving face 320a side of the light guide plate 320 that face the LEDs 328, the light that enters the light-receiving face 320a of the light guide plate 320 and proceeds towards the opposite surface 320c passes therethrough and arrives at the positions that overlap with the interior regions of the substrate recesses 330S when viewed in a plan view. That is, the light arrives at and is blocked by the sections 334TB (an example of first light-incident portions or light-shielding portions) of the casing 334. Meanwhile, in the portions of the light-receiving face 320a side of the light guide plate 320 that face the spaces between adjacent LEDs 328, the light that enters the light-receiving face 320a of the light guide plate 320 and proceeds towards the opposite surface 320c arrives at the LED 328-side surface (that is, the opposite surface 320c-side surface) of the substrate protrusions (an example of second light-incident portions or light-reflecting portions) and is reflected back into the light guide plate 320. As a result, similar to Embodiment 4, along the light-receiving face 320a side of the light guide plate 320, the brightness of the portions that face the LEDs 328 and would normally be bright is reduced, and the brightness of the portions that face the spaces between adjacent LEDs 328 and would normally be dark is increased. This results in a smaller difference in brightness between the portions that face the LEDs 328 and the portions that face the spaces between adjacent LEDs 328 along the light-receiving face 320a side of the light guide plate 320. Therefore, the brightness along the light-receiving face 320a side of the light guide plate 320 is approximately uniform, and as a result, irregularities in brightness along the light-receiving face 320a side of the light guide plate 320 can be easily reduced or prevented.

Next, the modification examples of the embodiments will be summarized. (1) In the abovementioned embodiments, the first light-incident portions are light-shielding portions to which a light-shielding treatment has been applied, and the second light-incident portions are light-reflecting portions to which a light reflection treatment has been applied. However, a treatment does not necessarily need to be applied to both the first light-incident portions and the second light-incident portions as long as the second light-incident portions have a higher optical reflectance than the first light-incident portions.

(2) In the abovementioned embodiments, a white color or a black color was applied to the surfaces of the flexible substrate to apply light-shielding or light-reflecting properties thereto. However, a printing process may be used to apply a white color or a black color to the substrate protrusions to apply light-shielding or light-reflecting properties thereto, white or black tape may be applied to the surfaces of the flexible substrate to apply light-shielding or light-reflecting properties thereto, or another process may be used on the substrate protrusions to apply light-shielding or light-reflecting properties thereto.

(3) In the abovementioned embodiments, a white color or a black color was applied to the surfaces of the light-exiting surface sheets to apply light-shielding or light-reflecting properties thereto. However, a printing process may be used to apply a white color or a black color to the light-exiting surface sheets to apply light-shielding or light-reflecting properties thereto, white or black tape may be applied to the surfaces of the light-exiting surface sheets to apply light-shielding or light-reflecting properties thereto, or another process may be used on the light-exiting surface sheets to apply light-shielding or light-reflecting properties thereto.

(4) In Embodiments 2 to 4, a printing process was used to apply a light-shielding treatment or a light reflection treatment to a portion of the optical sheet, a portion of the reflective sheet, or a portion of the casing. However, white or black tape may be applied to those portions to apply light-shielding or light-reflecting properties thereto, or another process may be used on those portions to apply light-shielding or light-reflecting properties thereto.

(5) In the abovementioned embodiments, black was used as the light-shielding color and white was used as the light-reflecting color. However, a combination of black and gray may be used for the light-shielding color and a combination of white and gray may be used for the light-reflecting color, or other single colors or combinations of other colors may be used for the light-shielding color and the light-reflecting color. Alternatively, the optical reflectance of the first light-incident portions and second light-incident portions may be adjusted by changing the color density of the colors used.

(6) The arrangement, shapes, and other properties of the substrate recesses and substrate protrusions formed in the flexible substrate may be changed as appropriate to achieve configurations other than those used in the abovementioned embodiments.

(7) The configuration and other properties of the portions that overlap with the interior regions of the substrate recesses when viewed in a plan view may be changed as appropriate to achieve configurations other than those used in the abovementioned embodiments.

(8) In the abovementioned embodiments, configurations in which substrate recesses and substrate protrusions are formed in an LED substrate suitable for use in a small backlight device or the like were described. However, the configurations of the abovementioned embodiments may also be applied for use in a large backlight device or the like. In this case, the substrate on which the LEDs are mounted may be a non-flexible LED substrate.

(9) In the abovementioned embodiments, liquid crystal display devices in which a liquid crystal panel is used for the display panel were described. However, the present invention may also be applied to display devices in which other types of display panels are used.

Embodiments of the present invention were described in detail above, but these are nothing more than examples and do not limit the scope of the claims in any way. The technology disclosed in the claims also includes a variety of variations and modifications to the specific examples described above.

Moreover, elements of the technology described in the present specification and drawings exhibit technical utility when used either singularly or in combination. The present invention is not limited to the combinations of the technical elements presented in the claims when the present application was filed. Moreover, the technology disclosed in the present specification and drawings simultaneously achieves multiple technical effects. Achieving any one of these technical effects constitutes exhibition of technical utility.

### DESCRIPTION OF REFERENCE CHARACTERS

10, 210, 310 liquid crystal display device

11, 211, 311 liquid crystal panel

12, 212, 312 cover panel

14, 214, 314 panel adhesive tape

16, 216, 316 light-exiting surface sheet

18, 118, 218, 318 optical sheet

20, 120, 220, 320 light guide plate

20a, 120a, 220a, 320a light-receiving face

20b, 120b, 220b, 320b light-exiting surface

20c, 120c, 220c, 320c opposite surface

22, 122, 222, 322 frame

24, 224, 324 backlight device

26, 126, 226, 326, 326L reflective sheet

28, 128, 228, 328 LED

30, 130, 230, 330 flexible substrate

30S, 130S, 230S, 330S substrate recess

30TW, 30TB, 130TW, 130TB, 230TW, 230TB, 330TW, 330TB substrate protrusion

31 overlapping portion

32, 232, 332 casing adhesive tape

34, 234, 334, 335 casing

1. An illumination device, comprising:
a light guide plate having a light-exiting surface on one surface thereof, an opposite surface on another surface thereof, and a light-receiving face on at least one end face thereof;
a light source substrate having: an overlapping portion disposed so as to overlap and contact one end of either said light-exiting surface or said opposite surface adjacent to the light-receiving face in a plan view; recesses formed in said overlapping portion and opened towards a center of the light guide plate; and protrusions formed on the overlapping portion and protruding towards the center of the light guide plate, said recesses and protrusions being alternately arranged parallel to the light-receiving face of the light guide plate; and
a plurality of side-illumination type light sources that are arranged parallel to one another on the light source substrate along the light-receiving face of the light guide plate such that light-emitting surfaces of the light sources oppose said light-receiving face, said plurality of light sources being arranged so as to respectively face one of either the recesses or the protrusions of the light source substrate and such that gaps between the adjacent light sources face the other of either the recesses or the protrusions of the light source substrate,
wherein the illumination device is configured to have a first light-incident portion that is disposed at one of either a position overlapping an inner area of the recesses in a plan view or a surface of the protrusions facing the light sources, such that light emitted from the light sources and traveling to a location on the light-receiving face opposing the light sources in a plan view arrives at the first light-incident portion, and
wherein the illumination device is further configured to have a second light-incident portion that is disposed at the other of either the position overlapping the inner area of the recesses in a plan view or the surface of the protrusions facing the light sources, such that light emitted from the light sources and traveling to a location on the light-receiving face opposing the gaps between the adjacent light sources arrives at the second light-incident portion, said second-light incident portion having a higher light reflectance than said first light-incident portion.

2. The illumination device according to claim 1,
wherein the first light-incident portion is a light-shielding portion to which a light-shielding treatment has been applied, and
wherein the second light-incident portion is a light-reflecting portion to which a light-reflecting treatment has been applied.

3. The illumination device according to claim 1, further comprising:
a light-exiting surface sheet arranged on a surface of the light source substrate opposite to a surface where the light sources are disposed and partially overlapping the inner area of the recesses in a plan view, said light-exiting surface sheet having at least a surface facing the light source substrate being a light-shielding color,
wherein the light source substrate has at least the protrusions thereon being a light-reflecting color, said light source substrate being arranged such that the recesses therein face the respective light sources in a plan view and the protrusions thereon face the respective gaps between the adjacent light sources in a plan view, and such that the overlapping portion of the light source substrate contacts an end of the light-exiting surface of the light guide plate near the light-receiving face thereof.

4. The illumination device according to claim 1, further comprising:
a light-exiting surface sheet arranged on a surface of the light source substrate opposite to a surface where the light sources are disposed and partially overlapping the inner area of the recesses in a plan view, at least a surface facing the light source substrate of said light-exiting surface sheet being a light-reflecting color,
wherein the light source substrate has at least the protrusions thereon being a light-shielding color, said light source substrate being arranged such that the recesses therein face the respective gaps between the adjacent light sources in a plan view and the protrusions thereon face the respective light sources in a plan view, and such that the overlapping portion of the light source substrate contacts an end of the light-exiting surface of the light guide plate near the light-receiving face thereof.

5. The illumination device according to claim 1, further comprising:
an optical sheet in contact with the light-exiting surface of the light guide plate and that exerts an optical effect on light that has exited therefrom, said optical sheet having recesses formed in an end thereof near the light-receiving face of the light guide plate and opened towards the light sources, and protrusions formed in an end thereof near the light-receiving face of the light guide plate and protruding towards the light sources, said recesses and protrusions being alternately arranged parallel to the light-receiving face of the light guide plate and at least the protrusions being a light-shielding color,
wherein the light source substrate has at least the protrusions thereon being a light-reflecting color, said light source substrate being arranged such that the recesses therein face the respective light sources in a plan view and the protrusions thereon face the respective gaps between the adjacent light sources in a plan view, and such that the overlapping portion of the light source substrate contacts an end of the light-exiting surface of the light guide plate near the light-receiving face thereof, and
wherein the optical sheet and the light source substrate are arranged such that the protrusions on the optical sheet engage the recesses in the light source substrate, and the protrusions on the light source substrate engage the recesses in the optical sheet.

6. The illumination device according to claim 1, further comprising:
an optical sheet in contact with the light-exiting surface of the light guide plate and that exerts an optical effect on light that has exited therefrom, said optical sheet having recesses formed in an end thereof near the light-receiving face of the light guide plate and opened towards the light sources, and protrusions formed in an end thereof near the light-receiving face of the light guide plate and protruding towards the light sources, said recesses and protrusions being alternately arranged parallel to the light-receiving face of the light guide plate and at least the protrusions being a light-shielding color,
wherein the light source substrate has at least the protrusions thereon being a light-reflecting color, said light source substrate being arranged such that the recesses therein face the respective gaps between the adjacent light sources in a plan view and the protrusions thereon face the respective light sources in a plan view, and such that the overlapping portion of the light source substrate contacts an end of the light-exiting surface of the light guide plate near the light-receiving face thereof, and
wherein the optical sheet and the light source substrate are arranged such that the protrusions on the optical sheet engage the recesses in the light source substrate, and the protrusions on the light source substrate engage the recesses in the optical sheet.

7. The illumination device according to claim 1, further comprising:
a reflective sheet in contact with the opposite surface of the light guide plate and that reflects light that has leaked from said opposite surface back toward the light guide plate, said reflective sheet having recesses formed in an end thereof near the light-receiving face of the light guide plate and opened towards the light sources, and protrusions formed in an end thereof near the light-receiving face of the light guide plate and protruding towards the light sources, said recesses and protrusions being alternately arranged parallel to the light-receiving face of the light guide plate and at least the protrusions being a light-shielding color,
wherein the light source substrate has at least the protrusions thereon being a light-reflecting color, said light source substrate being arranged such that the recesses therein face the respective light sources in a plan view and the protrusions thereon face the respective gaps between the adjacent light sources in a plan view, and such that the overlapping portion of the light source substrate contacts an end of the opposite surface of the light guide plate near the light-receiving face thereof, and
wherein the reflective sheet and the light source substrate are arranged such that the protrusions on the reflective sheet engage the recesses in the light source substrate, and the protrusions on the light source substrate engage the recesses in the reflective sheet.

8. The illumination device according to claim 1, further comprising:
a reflective sheet in contact with the opposite surface of the light guide plate and that reflects light that has leaked from said opposite surface back toward the light guide plate, said reflective sheet having recesses formed in an end thereof near the light-receiving face of the light guide plate and opened towards the light sources, and protrusions formed in an end thereof near the light-receiving face of the light guide plate and protruding towards the light sources, said recesses and protrusions being alternately arranged parallel to the light-receiving face of the light guide plate and at least the protrusions being a light-reflecting color,
wherein the light source substrate has at least the protrusions thereon being a light-shielding color, said light source substrate being arranged such that the recesses therein face the respective gaps between the adjacent light sources in a plan view and the protrusions thereon face the respective light sources in a plan view, and such that the overlapping portion of the light source substrate contacts an end of the light-exiting surface of the light guide plate near the light-receiving face thereof, and
wherein the reflective sheet and the light source substrate are arranged such that the protrusions on the reflective sheet engage the recesses in the light source substrate, and the protrusions on the light source substrate engage the recesses in the reflective sheet.

9. The illumination device according to claim 1, further comprising:
a support member on the opposite surface of the light guide plate having at least a support surface along said opposite surface for supporting a side of the light source substrate opposite to a side on which the light sources are arranged, the support member having a light-shielding color at a location on the support surface thereof overlapping inner area of the recesses in the light source substrate in a plan view,
wherein the light source substrate has at least the protrusions thereon being a light-reflecting color, said light source substrate being arranged such that the recesses therein face the respective gaps between the adjacent light sources in a plan view and the protrusions thereon face the respective light sources in a plan view, and such that the overlapping portion of the light source substrate contacts an end of the light-exiting surface of the light guide plate near the light-receiving face thereof.

10. The illumination device according to claim 1, further comprising:
a support member on the opposite surface of the light guide plate having at least a support surface along said opposite surface for supporting a side of the light source substrate opposite to a side on which the light sources are arranged, the support member having a light-reflecting color at a location on the support surface thereof overlapping inner area of the recesses in the light source substrate in a plan view,
wherein the light source substrate has at least the protrusions thereon being a light-reflecting color, said light source substrate being arranged such that the recesses therein face the respective gaps between the adjacent light sources in a plan view and the protrusions thereon face the respective light sources in a plan view, and such that the overlapping portion of the light source substrate contacts an end of the light-exiting surface of the light guide plate near the light-receiving face thereof.

11. The illumination device according to claim 2 any, wherein a degree of recess in the light source substrate and a degree of protrusion on the light source substrate at both ends on the overlapping portion on the light guide plate in an arrangement direction of the light sources is greater than a degree of recess in the light source substrate and a degree of protrusion on the light source substrate at other locations.

12. The illumination device according to claim 1,
wherein the light-reflecting color is white, and
wherein the light-shielding color is black.

13. The illumination device according to claim 1,
wherein the light source substrate is a flexible substrate, and
wherein each of the light sources is arranged such that a light-emitting surface thereof is near the light-receiving face of the light guide plate.

14. A display device, comprising:
the illumination device according to claim 1; and
a display panel that display images using light from the illumination device.

15. The display device according to claim 14, wherein the display panel is a liquid crystal panel comprising liquid crystal sealed between a pair of substrates.
